(19) United States
(12) Patent Application Publication
(10) Pub. No.: US 2013/0102740 A1
(43) Pub. Date: Apr. 25, 2013

(54) SULFONATED POLY(ARYLENE ETHER) COPOLYMER HAVING A CROSS-LINKABLE STRUCTURE, AND POLYELECTROLYTE MEMBRANE COMPRISING SAME

(71) Applicants: Jae-Suk Lee, Buk-gu (KR); Young Jea Kim, Buk-gu (KR); Hyo Kyeong Son, Buk-gu (KR); Da Young Kim, Buk-gu (KR); Un Ko, Buk-gu (KR)

(72) Inventors: Jae-Suk Lee, Buk-gu (KR); Young Jea Kim, Buk-gu (KR); Hyo Kyeong Son, Buk-gu (KR); Da Young Kim, Buk-gu (KR); Un Ko, Buk-gu (KR)

(73) Assignee: GWANGJU INSTITUTE OF SCIENCE AND TECHNOLOGY, Buk-gu, Gwangju (KR)

(21) Appl. No.: 13/807,455

(22) PCT Filed: Jul. 13, 2011
(86) PCT No.: PCT/KR2011/005157

§ 371 Date: Dec. 28, 2012

(30) Foreign Application Priority Data
Jul. 15, 2010 (KR) 10-2010-0068481

(51) Int. Cl. C08G 75/23; C08G 65/40

(52) U.S. Cl. CPC C08G 75/23; C08G 65/40
USPC 525/534; 528/174

(57) ABSTRACT

Provided are a sulfonated poly(arylene ether) copolymer including a crosslinking structure and a polyelectrolyte membrane including the same. Particularly, a sulfonated poly(arylene ether) copolymer including a crosslinking structure in a polymer chain or at the terminal portion of the polymer chain, and a polyelectrolyte membrane including the same are provided. The polyelectrolyte membrane using the sulfonated poly(arylene ether) copolymer including the crosslinking structure, may have the same or better degree of a thermal stability, a mechanical stability, a chemical stability, a membrane forming capability, etc. than a commonly used polyelectrolyte membrane. In addition, the proton conductivity and the cell performance of the polyelectrolyte membrane may be remarkably improved than those of the commonly used polymer electrolyte. Further, the properties of the electrolyte membrane may be rarely changed, and a high measuring stability may be obtainable. The polyelectrolyte membrane may be used in a fuel cell or a secondary battery.

### TECHNICAL FIELD

The present invention disclosed herein relates to a sulfonated poly(arylene ether) copolymer including a crosslinking structure and a polyelectrolyte membrane including the same, and more particularly, to a sulfonated poly(arylene ether) copolymer including a crosslinking structure at the inner or terminal part of a polymer chain and a polyelectrolyte membrane including the same.

### BACKGROUND ART

A fuel cell is an electric energy transforming system discovered at 19^{th} century by Grove and transforms chemical energy into electric energy through an electrochemical reaction. The fuel cell has been used in 1960s for a specific object such as in the Gemini spaceship. However, the fuel cell has been expected to be applied as a power source of a nonpolluting vehicle from the late 1980s, and recently, researches and developments on the fuel cell are actively conducted as an alternative energy in response to the explosive increase of the population and the electricity demand all over the world. Particularly, as the regulation on the total amount of carbon dioxide through the Green Round, and the regulation on the exhausting gas of a vehicle through an obligation of selling low-polluting vehicles, etc. are approached, automobile companies in every country are hurrying the development of the nonpolluting vehicles such as the fuel cell vehicles.

In addition, the fuel cell may be readily applied in a small-sized generator for being locally installed in a building and in some areas, and in a munitions industry such as a submarine, a mobile communication, etc. The fuel cell may not accumulate electricity, however, has a higher efficiency and consumes less fuel than a commonly used internal combustion engine, and rarely exhausts environmentally loading materials such as sulfur oxides (SOx), nitrogen oxides (NOx), etc. Thus, the fuel cell is expected as a clean and highly efficient generating unit for solving the recently emerging environmental problems accompanied with the use of the fossil fuel.

Polyelectrolyte used as a cation exchange resin or a cation exchange membrane in a fuel cell has been used for decades and has been studied consistently. Recently, researches on the cation exchange membrane have been conducted as a medium of delivering cations used in a direct methanol fuel cell (DMFC), or in a polymer electrolyte membrane fuel cell (PEMFC; alternatively, a solid polymer electrolyte fuel cell, a solid polymer fuel cell, or a proton exchange membrane fuel cell).

As the cation exchange membrane widely used nowadays in the fuel cell field, a Nafion™-based membrane, which is a perfluorinated sulfonic acid group containing polymer and manufactured by DuPont de Nemours and Company in the USA may be illustrated. This membrane has a good ion conductivity of 0.1 S/cm when saturated with water, a good mechanical strength and chemical-resistance and a stable performance. Thus, the membrane may be used as an electrolyte membrane in a fuel cell for a vehicle. As similar compatible membranes, an Aciplex-S membrane of Asahi Chemicals, a Dow membrane of a Dow Chemicals, a Flemion membrane of Asahi Glass, a GoreSelect membrane of Gore & Associate, etc. may be illustrated. In addition, alpha or beta type perfluorinated polymer is under development by Ballard Power System in Canada.

However, the above described membranes are expensive, the manufacturing thereof is complicated, and a mass production thereof is difficult. In addition, an electric energy system such as the DMFC may be used in a limited shape, because of a methanol cross-over phenomenon and a remarkable efficiency lowering property, for example, low proton conductivity at a high temperature or at a low temperature as a cation exchange membrane.

Considering the above described limitations, researches on non-fluorine-based and partially fluorine substituted cation exchange membranes have been conducted a lot. Typically, a sulfonated poly(phenylene oxide)-based, poly(phenylene sulfide)-based, polysulfone-based, poly(para-phenylene)-based, polystyrene-based, polyetheretherketone-based or polyimide-based membrane may be illustrated.

However, since the ion conductivity of the membrane is proportional to the sulfonation degree, when the sulfonation degree exceeds a critical concentration, the lowering of a molecular weight may be inevitable. In addition, the mechanical properties of the membrane may be decreased after being hydrated, and in this case, the membrane may not be used for a long time. In order to improve the limitations, a method of manufacturing a polymer by using a sulfonated monomer and a method of selectively sulfonating polymer have been developed (see U.S. Pat. Nos. 5,468,574, 5,679,482 and 6,110,616). However, the limitations concerning the stability at a high temperature and after the long use have been incompletely solved.

Accordingly, a novel material having good electrochemical properties and a good stability at a high temperature, and easily producing a thin membrane is urgently in need.

### DISCLOSURE

### Technical Problem

The present invention provides a sulfonated poly(arylene ether) copolymer including a crosslinking structure, which may pro duce a polyelectrolyte membrane having a good thermal stability, a good mechanical stability, a good chemical stability, a good membrane forming capability, etc., as well as a good proton conductivity, a good cell performance, a good measuring stability, etc., and a polyelectrolyte including the sane.

### Technical Solution

In accordance with an exemplary embodiment of the present invention,

a sulfonated poly(arylene ether) copolymer represented by the following Chemical Formula 1 or Chemical Formula 2 is provided:

O—SAr1-OₖAr1_{b}O—Ar2-Oₘ(Ar3_{d}O-CM-Oₛₙ [Chemical Formula 1]

O—Ar4-CₖSAr2_{b}O-CM-OₛAr5_{d}ₙ [Chemical Formula 2]

in Chemical Formula 1 and Chemical Formula 2,

SAr1 and SAr2 are the same or different and independently represent a sulfonated aromatic group,

Ar1, Ar2, Ar3, Ar4 and Ar5 are the same or different and independently represent a none sulfonated aromatic group,

CM represents a crosslinkable moiety,

k represents a number from 0.001 to 0.999, m represents a number from 0 to 1, s represents a number of (1−k−m), b represents a number from 0.001 to 1, and d represents a number of (1−b), and

n represents a repeating unit of a polymer and an integer from 10 to 500.

In accordance with another exemplary embodiment of the present invention,

a sulfonated poly(arylene ether) copolymer represented by the following Chemical Formula 3 is provided.

CM′SAr3ₖAr6ₛ-O—Ar7-Oₙ-CM′ [Chemical Formula 3]

in Chemical Formula 3,

SAr3 independently represents a sulfonated aromatic group,

Ar6 and Ar7 are the same or different and independently represent a none sulfonated aromatic group,

CM′ represents a crosslinkable moiety,

k represents a number from 0.001 to 0.999, and s represents a number of (1-k), and

n represents a repeating unit of a polymer and an integer from 10 to 500.

In accordance with another exemplary embodiment of the present invention,

a method of manufacturing a sulfonated poly(arylene ether) copolymer represented by Chemical Formula 1 or Chemical Formula 2, is provided. The method includes forming a polymer by condensation polymerizing at least one monomer selected from the group consisting of a sulfonated dihydroxy monomer, a none sulfonated dihydroxy monomer, a sulfonated dihalide monomer and a none sulfonated dihalide monomer, with a crosslinkable compound.

In accordance with still another exemplary embodiment of the present invention,

a method of manufacturing a sulfonated poly(arylene ether) copolymer represented by Chemical Formula 3, is provided.

The method includes 1) forming a polymer by condensation polymerizing at least one monomer selected from the group consisting of a sulfonated dihydroxy monomer, a none sulfonated dihydroxy monomer, a sulfonated dihalide monomer and a none sulfonated dihalide monomer; and

2) performing a substitution reaction at a terminal of the formed polymer using a crosslinkable compound.

In accordance with still further another exemplary embodiment of the present invention, a polyelectrolyte membrane including the sulfonated poly(arylene ether) copolymer represented by Chemical Formula 1, Chemical Formula 2 or Chemical Formula 3 is provided.

In accordance with still further another exemplary embodiment of the present invention, a crosslinkable compound including at least one crosslinkable group selected from the group consisting of following structures is provided.

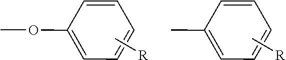

in the structures, R represents

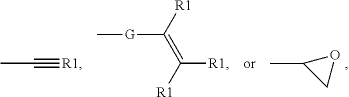

G represents a single bonding,

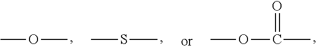

R1 represents H, F, an alkyl group having 1 to 5 carbon atoms, or

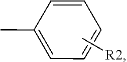

and

R2 represents H, F or an alkyl group having 1 to 5 carbon atoms.

### Advantageous Effects

According to exemplary embodiments, a polyelectrolyte membrane using a sulfonated poly(arylene ether) copolymer including a crosslinking structure may have the same or better thermal stability, mechanical stability, chemical stability, membrane forming capability, etc. when comparing with the commonly used polyelectrolyte membrane. In addition, the polyelectrolyte membrane may have remarkably improved proton conductivity and cell performance when comparing with the common, polyelectrolyte membrane. Further, the electrolyte membrane characteristics may not be changed even though exposed to humidity for a long time, and a high measuring stability may be obtainable. The polyelectrolyte membrane may be used in a fuel cell, a secondary battery, etc.

### DESCRIPTION OF DRAWINGS

FIG. 1 is an NMR spectrum on 1,4-bis(tert-butyldimethylsiloxy)-2-bromobenzene in accordance with Preparation Example 1.

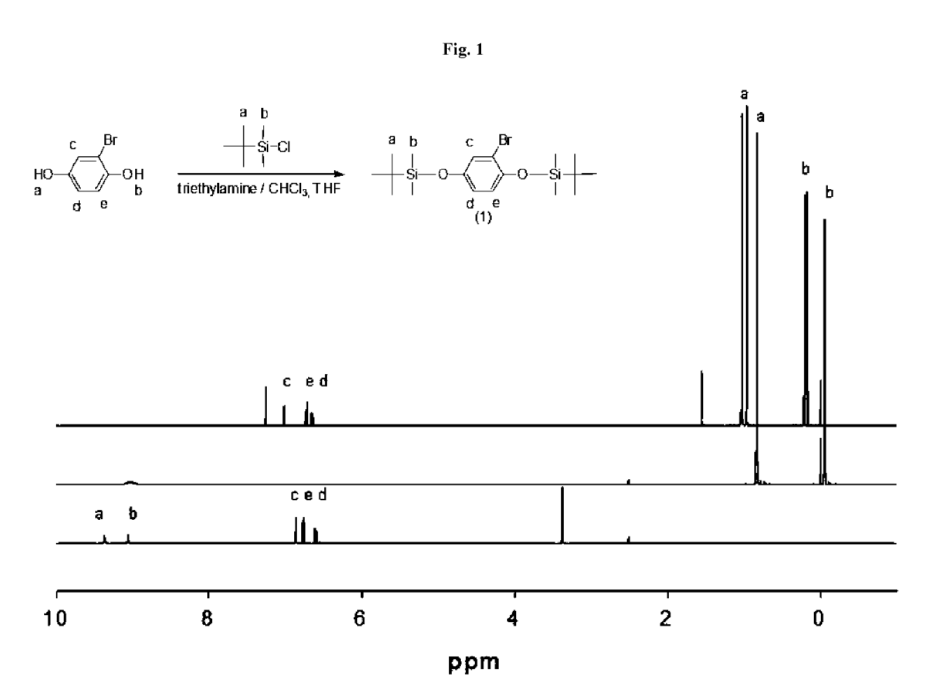

FIG. 2 is an NMR spectrum on 1,4-bis(tert-butylmethylsiloxy)-2-(trimethylethynyl)benzene in accordance with Preparation Example 1.

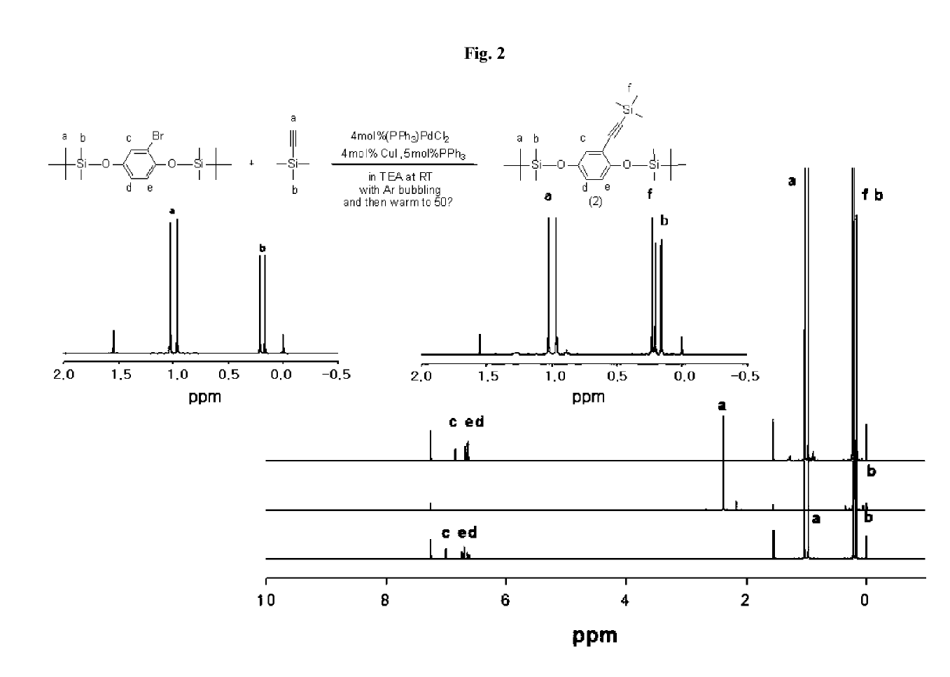

FIG. 3 is an NMR spectrum on ethynyl hydroquinone in accordance with Preparation Example 1.

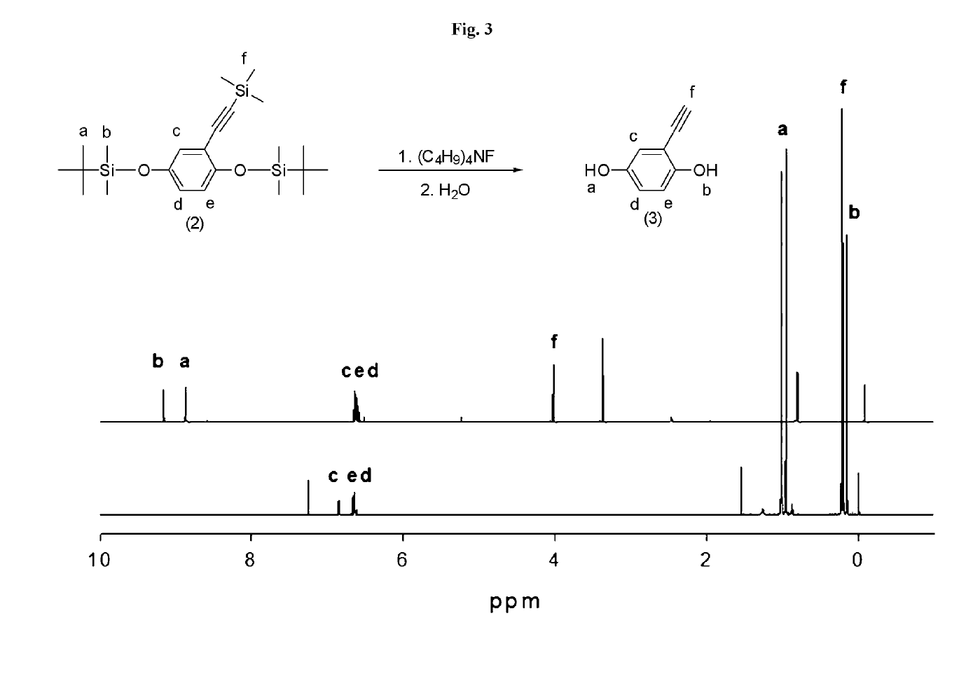

FIG. 4 is an NMR spectrum on a sulfonated poly(arylene ether) copolymer in accordance with Example 1.

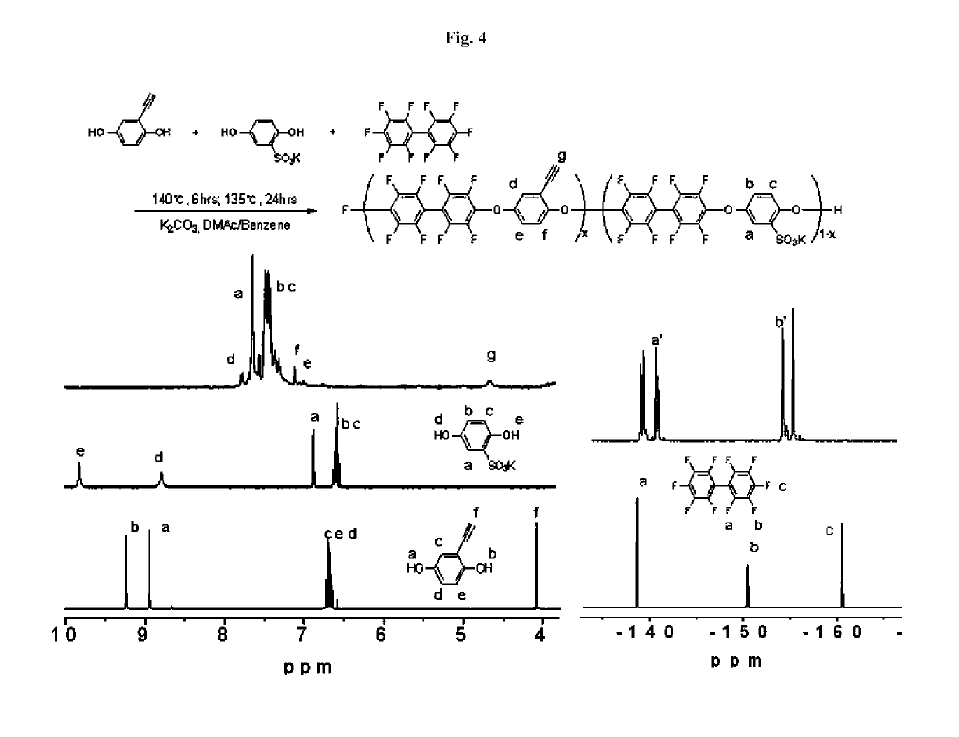

FIG. 5 is an NMR spectrum on a sulfonated poly(arylene ether) copolymer in accordance with Example 1.

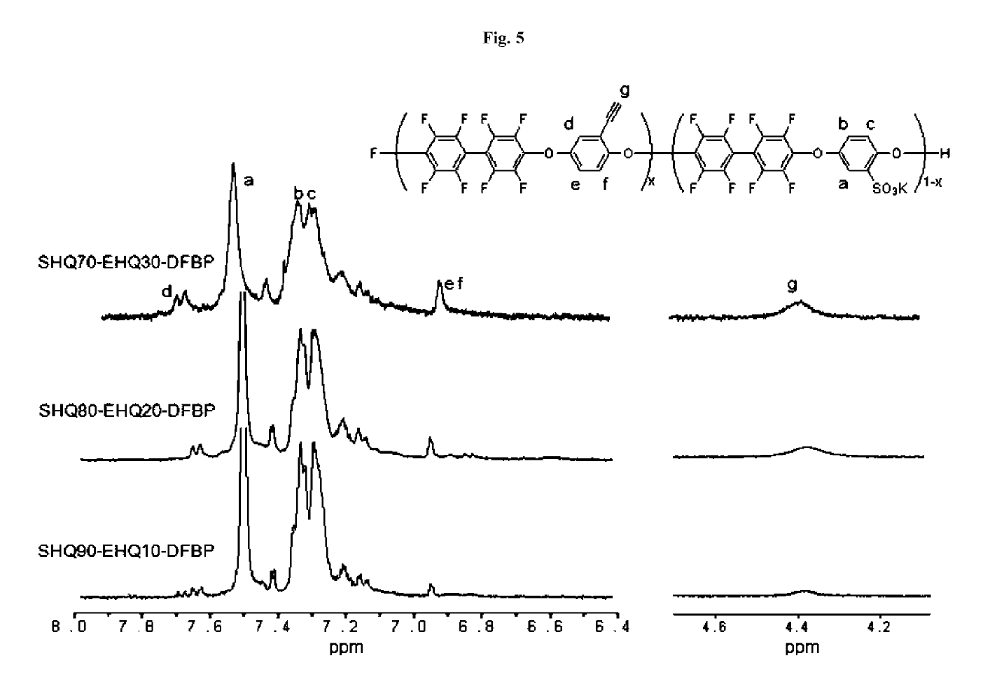

FIG. 6 is an absorption spectrum on a sulfonated poly(arylene ether) copolymer in accordance with Example 1.

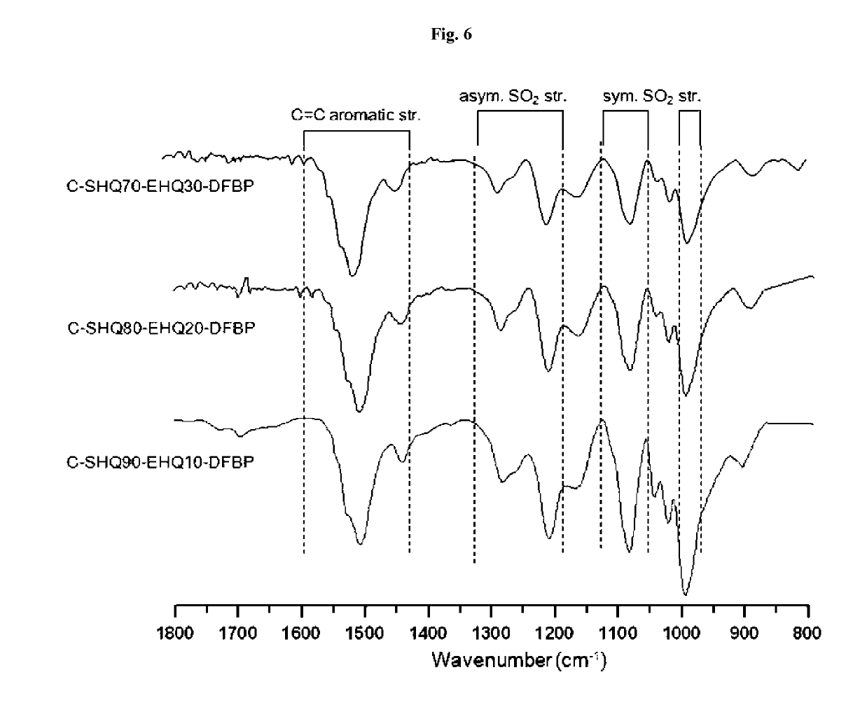

### BEST MODE

Hereinafter, the present invention will be explained in more detail.

Particular embodiments on a sulfonated poly(arylene ether) copolymer in accordance with exemplary embodiments, may be represented by the following Chemical Formula 1, Chemical Formula 2 or Chemical Formula 3.

O—SAr1-OₖAr1_{b}O—Ar2-Oₘ(Ar3_{d}O-CM-Oₛₙ [Chemical Formula 1]

O—Ar4-CₖSAr2_{b}O-CM-OₛAr5_{d}ₙ [Chemical Formula 2]

CM′SAr3ₖAr6ₛ-O—Ar7-Oₙ-CM′ [Chemical Formula 3]

in Chemical Formula 1, Chemical Formula 2 and Chemical Formula 3,

each of SAr1, SAr2 and SAr3 independently represents a sulfonated aromatic group,

each of Ar1, Ar2, Ar3, Ar4, Ar5, Ar6 and Ar7 independently represents a none sulfonated aromatic group,

CM and CM′ represent a crosslinkable moiety,

k represents a number from 0.001 to 0.999, m represents a number from 0 to 1, s represents a number of (1−k−m), b represents a number from 0.001 to 1, and d represents a number of (1−b), and

n represents a repeating unit of a polymer and an integer from 10 to 500.

In Chemical Formula 1, Chemical Formula 2 and Chemical Formula 3, each of SAr1, SAr2 and SAr3 may be independently selected from the group consisting of the following structures.

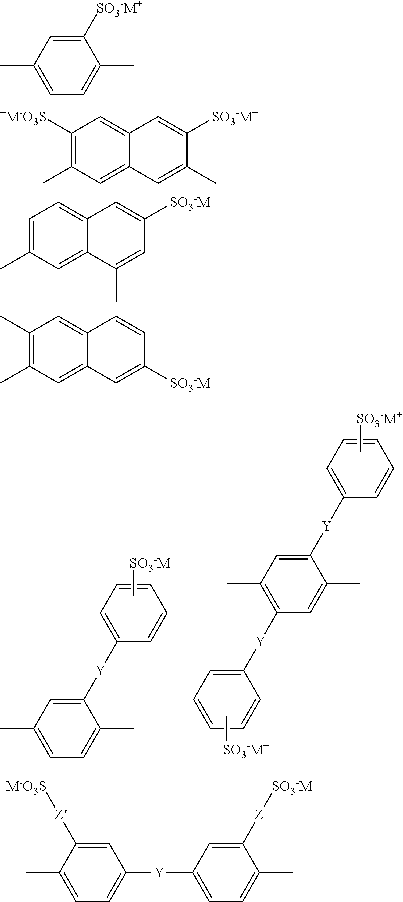

In the above structures, M⁺ represents a counterion having a cation and a potassium ion (K⁺), a sodium ion (Na⁺), or an alkyl amine (⁺NR′, here, R′ represents an alkyl having 1 to 5 carbon atoms), and preferably represents the potassium ion or the sodium ion,

Z represents a direct bonding,

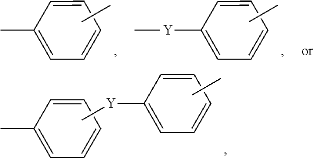

Y represents a single bonding, or is selected from the following structures,

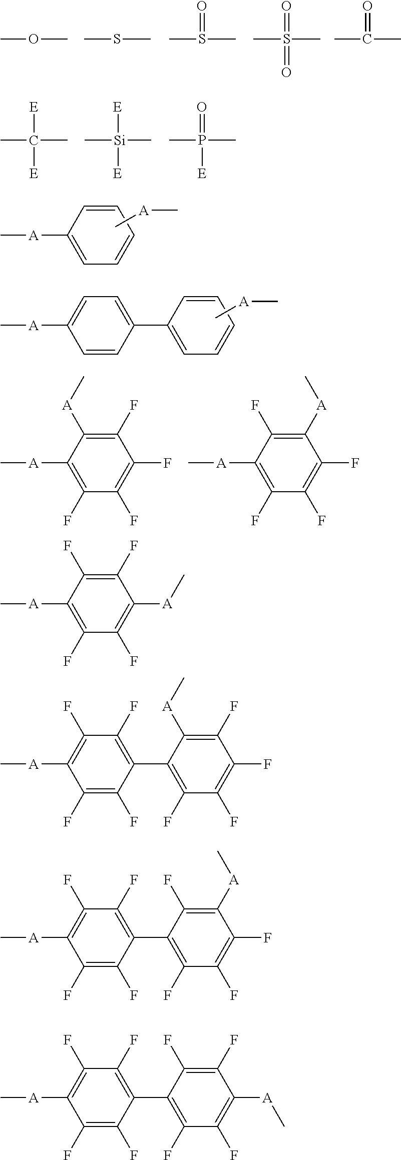

here, A represents a single bonding,

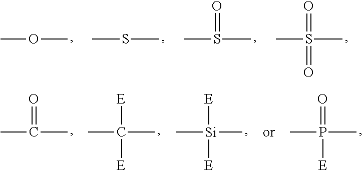

E represents H, F, an alkyl group having 1 to 5 carbon atoms, a haloalkyl group having 1 to 5 carbon atoms, or

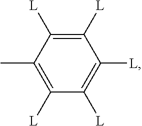

and

L represents H, F, an alkyl group having 1 to 5 carbon atoms, or a haloalkyl group having 1 to 5 carbon atoms.

In Chemical Formula 1, Chemical Formula 2 and Chemical Formula 3, each of Ar1, Ar2, Ar3, Ar4, Ar5, Ar6 and Ar7 may be independently selected from the group consisting of the following structures.

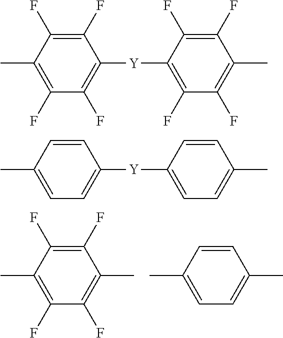

In the structures, Y represents a single bonding or one selected from the group consisting of following structures,

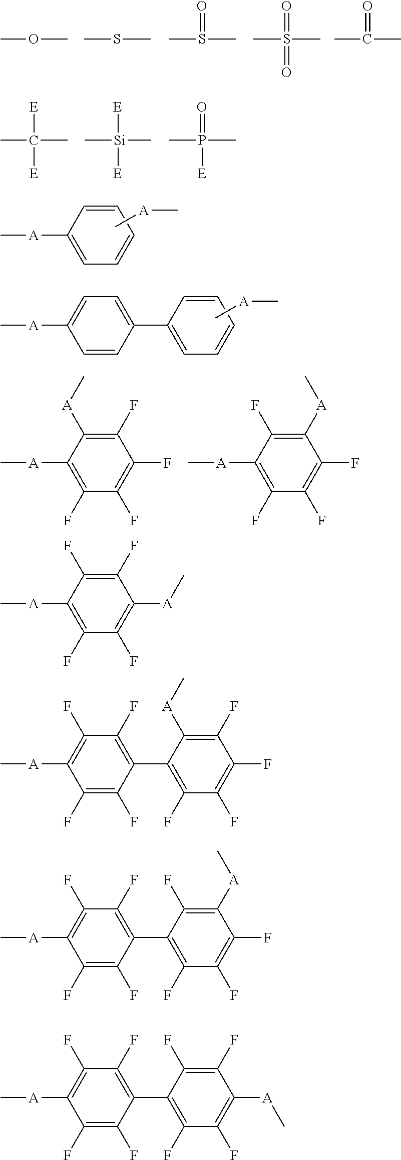

here, A represents a single bonding, or

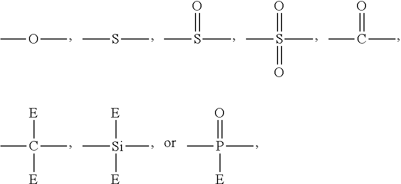

and

E represents hydrogen, F, an alkyl group having 1 to 5 carbon atoms, a haloalkyl group having 1 to 5 carbon atoms, or

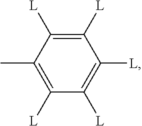

(here, L represents H, F, an alkyl group having 1 to 5 carbon atoms, or a haloalkyl group having 1 to 5 carbon atoms).

In Chemical Formula 1 and Chemical Formula 2, CM may be preferably selected from the group consisting of the following structures.

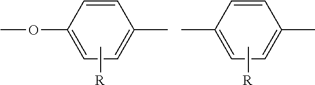

In the structures, R represents

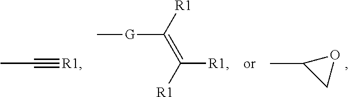

G represents a single bonding,

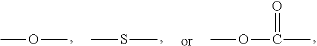

R1 represents H, F, an alkyl group having 1 to 5 carbon atoms, or

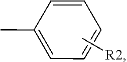

and

R2 represents H, F or an alkyl group having 1 to 5 carbon atoms.

In Chemical Formula 3, CM′ may be preferably selected from the group consisting of the following structures.

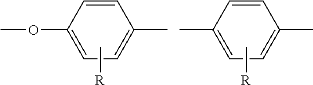

In the structures, R represents

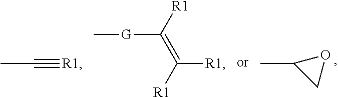

G represents a single bonding,

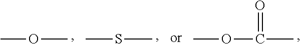

R1 represents H, F, an alkyl group having 1 to 5 carbon atoms, or

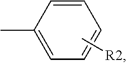

and

R2 represents H, F or an alkyl group having 1 to 5 carbon atoms.

In addition, an example embodiment on a method of manufacturing a sulfonated poly(arylene ether) copolymer represented by Chemical Formula 1 or Chemical Formula 2, includes forming a polymer by condensation polymerizing at least one monomer selected from the group consisting of a sulfonated dihydroxy monomer, a none sulfonated dihydroxy monomer, a sulfonated dihalide monomer and a none sulfonated dihalide monomer, with a crosslinkable compound.

In accordance with an example embodiment, a sulfonated poly(arylene ether) copolymer including a crosslinking structure in a polymer chain, represented by Chemical Formula 1 may be prepared by the following Reaction Formula 1. Particular explanation will be given as follows.

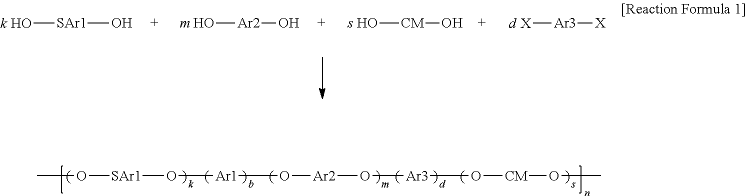

In Reaction Formula 1,

SAr1 represents a sulfonated aromatic group,

Ar1, Ar2 and Ar3 are the same or different, and independently represent a none sulfonated aromatic group,

CM represents a crosslinkable moiety,

X represents a halogen,

k represents a number from 0.001 to 0.999, m represents a number from 0 to 1, s represents a number of (1−k−m), b represents a number from 0.001 to 1, and d represents a number of (1-b), and

n represents a rep eating unit of a polymer and an integer from 10 to 500.

Reaction Formula 1 represents a reaction process for manufacturing the sulfonated poly(arylene ether) copolymer represented by Chemical Formula 1. The method for manufacturing the sulfonated poly(arylene ether) copolymer represented by Chemical Formula 1 corresponds to a condensation polymerization process, and the monomers participating the reaction may be changed. Particularly, the sulfonated monomer (HO-SAr1-OH) used in Reaction Formula 1 may be a dihydroxy monomer.

Through Reaction Formula 1, a sulfonated poly(arylene ether) copolymer including a crosslinking structure in a polymer chain may be prepared.

In Reaction Formula 1, a sulfonated dihydroxy monomer and a none sulfonated dihydroxy monomer may be activated first. The activation process is performed to facilitate the condensation polymerization of the dihydroxy monomer with the dihalide monomer.

In addition, the none sulfonated dihalide monomer may be added with the dihydroxy monomer at the same step.

First, the condensation polymerization is carried out in the presence of a solvent including a base, an azeotropic solvent and an aprotic polar solvent at a temperature range of 0° C. to 300° C. for 1 to 100 hours to prepare the polymer corresponding to Chemical Formula 1. Here, a protic polar solvent may be used instead of the aprotic polar solvent according to the manner of the manufacturing.

In addition, in order to improve the thermal stability, the electrochemical property, the membrane forming capability, the measuring stability, the mechanical stability, the chemical property, the physical property, the cell performance, etc., of the polymer, a crosslinkable moiety (CM) including a crosslinkable group for making a thermal crosslinking, may be substituted in the polymer chain to prepare the target in accordance with exemplary embodiments, that is, the sulfonated poly(arylene ether) copolymer including a crosslinking structure in the polymer chain represented by Chemical Formula 1.

In addition, according to the method of manufacturing the sulfonated poly(arylene ether) copolymer represented by Chemical Formula 1 or Chemical Formula 2 in accordance with exemplary embodiments, the crosslinkable compound may preferably include a crosslinkable group selected from the group consisting of the following structures.

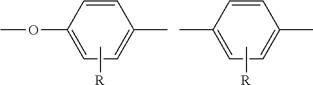

In the structures, R represents

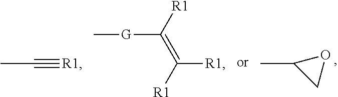

G represents a single bonding,

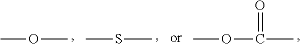

R1 represents H, F, an alkyl group having 1 to 5 carbon atoms, or

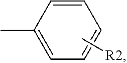

and

R2 represents H, F or an alkyl group having 1 to 5 carbon atoms.

As the base used in the condensation polymerization process and the introduction of the crosslinkable group for preparing the sulfonated poly(arylene ether) copolymer including the crosslinking structure in the polymer chain in accordance with exemplary embodiment, an inorganic base selected from the hydroxide, the carbonate and the sulfate of an alkali metal and an alkaline earth metal may be used, or an organic base selected from common amines including ammonia may be used.

In addition, the reaction solvent may include an aprotic polar solvent or a protic polar solvent. The aprotic polar solvent may include N-methylpyrrolidone (NMP), dimethyl formamide (DMF), N,N-dimethyl acetamide (DMAc), dimethyl sulfoxide (DMSO), etc. The protic polar solvent may include methylene chloride (CH₂Cl₂), chloroform (CH₃Cl), tetrahydrofuran (THF), etc., and the azeotropic solvent may include benzene, toluene, xylene, etc.

The sulfonated poly(arylene ether) copolymer including the crosslinking structure in the polymer chain may have the same or better degree of a thermal stability, a membrane forming capability, a mechanical stability, a chemical property, a physical property, a cell performance, etc. than the commonly used poly(arylene ether) copolymer or presently used polyelectrolyte membrane, the Nafion membrane. Particularly, the proton conductivity and the cell performance of the polyelectrolyte membrane are remarkably improved than the commonly used polymer electrolyte. Further, the properties of the electrolyte membrane may be rarely changed, and a high measuring stability may be obtainable.

In accordance with an example embodiment, the sulfonated poly(arylene ether) copolymer including the crosslinking structure in the polymer chain represented by Chemical Formula 2 may be prepared by the following Reaction Formula 18, and the particulars will be described in detail.

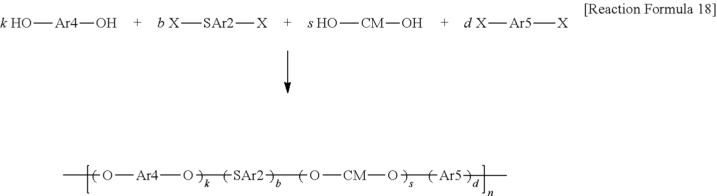

In Reaction Formula 18,

SAr2 represents a sulfonated aromatic group,

Ar4 and Ar5 are the same or different, and independently represent a none sulfonated aromatic group,

CM represents a crosslinkable moiety,

X represents a halogen,

k represents a numb er from 0.001 to 0.999, s represents a number of (1−k), b represents a number from 0.001 to 1, and d represents a number of (1−b), and

n represents a repeating unit of a polymer and an integer from 10 to 500.

Reaction Formula 18 represents a reaction process for preparing the sulfonated poly(arylene ether) copolymer represented by Chemical Formula 2. The method for preparing the polymer corresponding to the sulfonated poly(arylene ether) copolymer represented by Chemical Formula 2 may include a condensation polymerization process, and the monomers participating in the reaction may be changed. More particularly, the sulfonated monomer (X-SAr2-X) may use a dihalide monomer.

Through the Reaction Formula 18, the sulfonated poly(arylene ether) copolymer including the crosslinking structure in the polymer chain may be prepared.

In the Reaction Formula 18, a none sulfonated dihydroxy monomer may be activated. The activation process is performed to facilitate the condensation polymerization of the dihydroxy monomer with the dihalide monomer.

In addition, the none sulfonated dihalide monomer may be added with the dihydroxy monomer at the same step.

First, the condensation polymerization is carried out in the presence of a solvent including a base, an azeotropic solvent and an aprotic polar solvent at a temperature range of 0° C. to 300° C. for 1 to 100 hours to prepare the polymer corresponding to Chemical Formula 2. Here, a protic polar solvent may be used instead of the aprotic polar solvent according to the manner of the manufacturing.

In addition, in order to improve the thermal stability, the electrochemical property, the membrane forming capability, the measuring stability, the mechanical stability, the chemical property, the physical property, the cell performance, etc., of the polymer, a crosslinkable moiety (CM) including a crosslinkable group for making a thermal crosslinking, may be substituted in the polymer chain to prepare the target in accordance with exemplary embodiments, that is, the sulfonated poly(arylene ether) copolymer including the crosslinking structure in the polymer chain represented by Chemical Formula 2.

As the base used in the condensation polymerization process and the introduction of the crosslinkable group for preparing the sulfonated poly(arylene ether) copolymer including the crosslinking structure in the polymer chain in accordance with exemplary embodiment, an inorganic base selected from the hydroxide, the carbonate and the sulfate of an alkali metal and an alkaline earth metal may be used, or an organic base selected from common amines including ammonia may be used.

In addition, the reaction solvent may include an aprotic polar solvent or a protic polar solvent. The aprotic polar solvent may include N-methylpyrrolidone (NMP), dimethyl formamide (DMF), N,N-dimethyl acetamide (DMAc), dimethyl sulfoxide (DMSO), etc. The protic polar solvent may include methylene chloride (CH₂Cl₂), chloroform (CH₃Cl), tetrahydrofuran (THF), etc., and the azeotropic solvent may include benzene, toluene, xylene, etc.

In accordance with an example embodiment of a method of manufacturing a sulfonated poly(arylene ether) copolymer represented by following Chemical Formula 3, the method includes 1) forming a polymer by condensation polymerizing at least one monomer selected from the group consisting of a sulfonated dihydroxy monomer, a none sulfonated dihydroxy monomer, a sulfonated dihalide monomer and a none sulfonated dihalide monomer; and 2) performing a substitution reaction at the terminal of the polymer using a crosslinkable compound.

Particular process on the preparation of the polymer through the condensation polymerization of the monomer in step 1) may be the same as described above.

The substitution reaction in step 2) may be preferably performed by using a phenyl compound substituted with a halide or a phenyl compound substituted with a hydroxyl group.

The halide substituted phenyl compound and the hydroxyl substituted phenyl compound may be represented by the following structures, however, will not be limited to them.

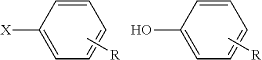

In the structures, X represents a halogen,

R represents

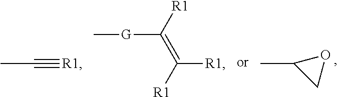

G represents a single bonding,

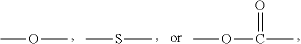

R1 represents H, F, an alkyl group having 1 to 5 carbon atoms, or

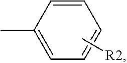

and

R2 represents H, F or an alkyl group having 1 to 5 carbon atoms.

In addition, a polyelectrolyte membrane including the sulfonated poly(arylene ether) copolymer represented by Chemical Formula 1, Chemical Formula 2 or Chemical Formula 3 may be provided in accordance with exemplary embodiments.

In addition, a crosslinkabie compound including at least one crosslinkable group selected from the group consisting of the following structures may be provided.

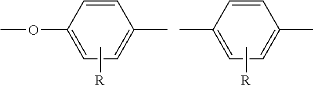

In the structures, R represents

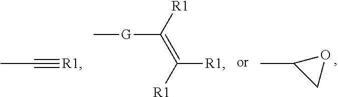

G represents a single bonding,

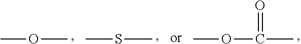

R1 represents H, F, an alkyl group having 1 to 5 carbon atoms, or

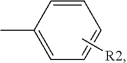

and

R2 represents H, F or an alkyl group having 1 to 5 carbon atoms.

As described above, the sulfonated poly(arylene ether) copolymer including the crosslinking structure in the polymer chain may have the same or better degree of a thermal stability, a membrane forming capability, a mechanical stability, a chemical property, aphysical property, a cell performance, etc. than the commonly used poly(arylene ether) copolymer or presently used polyelectrolyte membrane, the Nafion membrane. Particularly, the proton conductivity and the cell performance of the polyelectrolyte membrane are remarkably improved than the commonly used polymer electrolyte. Further, the properties of the electrolyte membrane may be rarely changed, and a high measuring stability may be obtainable even when exposed to humidity for a long time.

Hereinafter, preferred embodiments will be described to assist the understanding of exemplary embodiments. However, the embodiments are provided for an easy understanding of the exemplary embodiments, but do not intend to limit the content of the present invention.

### EXAMPLES

### Preparation Example 1

### Preparation of Monomer Including Crosslinkable Ethynyl Group with Dihydroxyl Group (EHQ)

The monomer in accordance with an example embodiment was prepared by the following Reaction Formula 2.

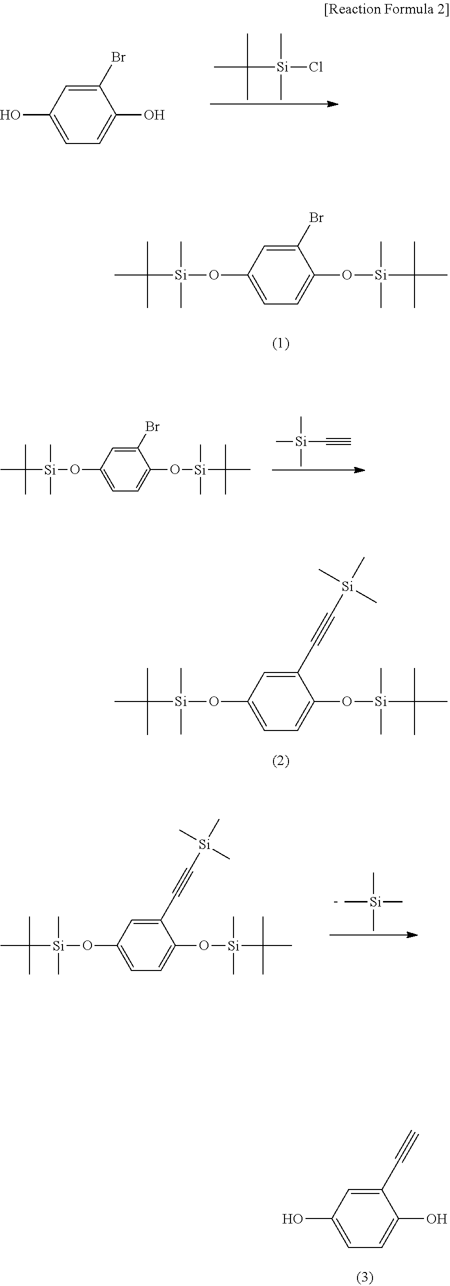

### (1) Preparation of 1,4-bis(tert-butyldimethylsiloxy)-2-bromobenzene

Compound (1) of Reaction Formula 2 was prepared by the following Reaction Formula 3.

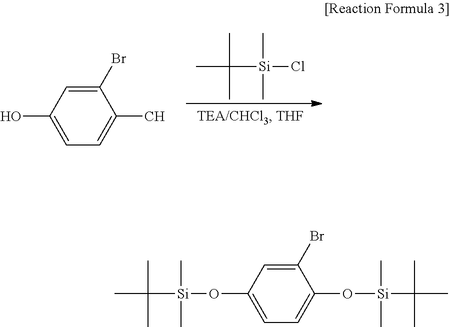

Into a 100 ml two-necked round bottom flask, equipped with a stirring apparatus and an magnetic stirring bar at an 0° C. environmental temperature, argon gas bubbling was applied and 0.026 mol of bromohydroquinone, 0.063 mol of triethylamine, 50 ml of chloroform, and 15 ml of tetrahydrofuran were added and activated. Then, 0.063 mol of tert-butyldimethylsilyl chloride was added and reacted at room temperature for 18 hours. After completing the reaction, the reaction product was poured into 50 ml of ice-water to cool, and impurities were removed by an extraction method using 100 ml of chloroform and an aqueous solution of saturated sodium bicarbonate. Remaining solvent was removed by a rotary evaporation method. Recrystallization was conducted using n-hexane and dimethylsulfoxide (DMSO), and the remaining solvent was removed by a freeze-drying method to obtain a final product. The production yield was 90% or more.

### (2) Preparation of 1,4-bis(tert-butyldimethylsiloxy)-2-(trimethylethynyl)benzene

Compound (2) of Reaction Formula 2 was prepared by the following Reaction Formula 4.

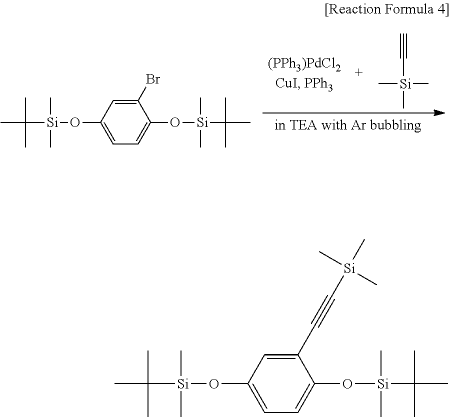

Into a 100 ml two-necked round bottom flask, equipped with a stirring apparatus and an magnetic stirring bar, argon gas bubbling was applied, and 50 ml of distilled triethylamine, 0.012 mol of 1,4-bis(tert-butyldimethylsiloxy)-2-bromobenzene, 0.00048 μmol of bis-(triphenylphosphine)palladium(I) chloride, 0.00060 mol of triphenylphosphine, and 0.00048 mol of copper(I) iodide were added and activated at room temperature. While maintaining the purging state using the argon gas, 0.0144 mol of trimethylsilylacetylene was added and reacted at 50° C. for 16 hours. After completing the reaction, precipitated triethylammonium salt was filtered. Remaining material was purified by extracting using n-hexane and then, dehydrated using sodium sulfate (Na₂SO₄). Then, purification was conducted by means of a column chromatography. The production yield was 70% or more.

### (3) Preparation of Ethynyl Hydroquinone

Compound (3) of Reaction Formula 2 was prepared by the following Reaction Formula 5.

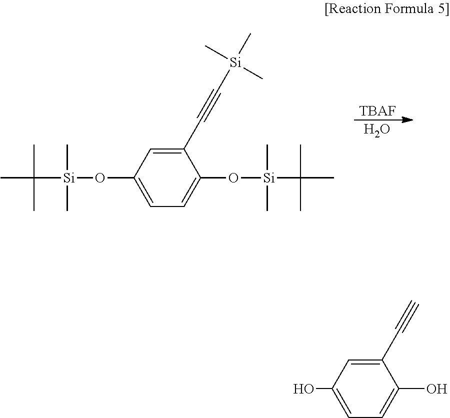

Into a 100 ml two-necked round bottom flask, equipped with a stirring apparatus and an magnetic stirring bar, 15 ml of 0.0046 mol of tetrahydrofuran (THF) and 0.0046 mol of 1,4-bis(tert-butylmethylsiloxy)-2-(trimethylethynyl)benzene prepared in (2) were added, and argon gas bubbling was applied. Then, the environment temperature was adjusted to 0° C., and 28 ml of tetra-n-butylammonium fluoride (TBAF) was added and stirred. After a while, the temperature was increased to 30° C. and the reaction was maintained for 4 hours. After completing the reaction, water and ethyl acetate were added to dilute, and a mixed organic layer was washed using an aqueous solution of saturated sodium chloride and water. Thus obtained product was dried using sodium sulfate (Na₂SO₄), filtered once, and concentrated by an evaporation method. Column chromatography was conducted to produce a final product. The production yield was 90% or more.

### Example 1

### Preparation of Sulfonated Poly(Arylene Ether) Copolymer Including Crosslinking Structure in Polymer Chain (SHQk-EHQs-DFBP, SHQk-EHQs-DFDPS)

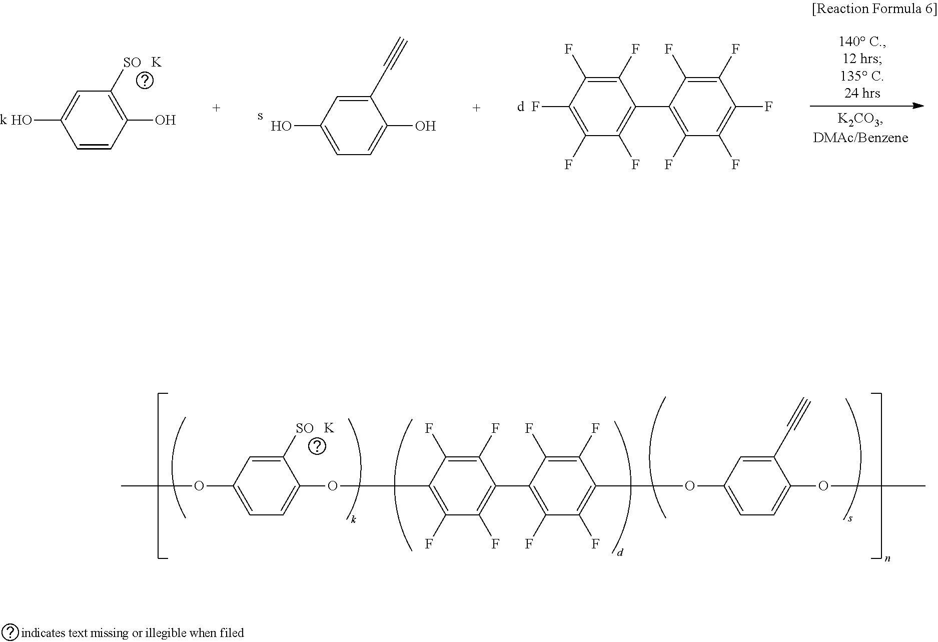

Into a two-necked 250 ml round bottom flask, equipped with a stirring apparatus, a nitrogen gas inlet, a magnetic stirring bar and a Dean-Stark azeotropic distillation apparatus, K₂CO₃ (1.25 mol eq.), N,N-dimethyl acetamide (DMAc; 40 ml) and benzene (20 ml) were added, with the molar ratio of hydroquinonesulfonic acid potassium salt being 13.5 mmol (k=1) and the molar ratio of ethynyl hydroquinone being 1.5 mmol (s=1).

An activation process was conducted at 140° C. for 12 hours, and water produced during the reaction as a by-product was removed by an azeotropic distillation method with benzene, one of the solvents. After completing the activation, benzene was removed from the reactor. Then, 15 mmol (d=1) of decafluorobiphenyl was added into the reactor and the reaction was kept at a reaction temperature of 140° C. for 24 hours. After the reaction, the product was precipitated in 1 L of ethanol, washed several times using ethanol, and dried at 60° C. for 3 clays under vacuum. Finally obtained product was a pale brown solid with a production yield of 90% or more.

The product was called as SHQk-EHQs-DFBP. In the name of the copolymer, SHQk-EHQs-DFBP, k represents the molar ratio of hydroquinonesulfonic acid potassium salt by the percent ratio, and s represents the molar ratio of ethynyl hydroquinone by the percent ratio.

Sulfonated poly(arylene ether) copolymers including the crosslinking structure in the polymer chain were prepared by using the starting materials of hydroquinonesulfonic acid potassium salt and ethynyl hydroquinone in molar ratios (k:s) of 13.5 mmol:1.5 mmol (k:s=0.9:0.1), 12 mmol:3 mmol (k:s=0.8:0.2) and 10.5 mmol:4.5 mmol (k:s=0.7:0.3). The copolymers prepared with different molar ratios of the starting materials were called as SHQ90-EHQ10-DFBP, SHQ80-EHQ20-DFBP, and SHQ70-EHQ30-DFBP, respectively. The yield of each compound was 90% or more.

Sulfonated poly(arylene ether) copolymers including the crosslinking structure in the polymer chain, SHQk-EHQs-DFDPS was prepared by conducting the same reaction except for using 4,4′-difluorodiphenyl sulfone instead of decafluorobiphenyl as represented by the following Reaction Formula 7. The copolymers prepared with different molar ratios (k:s) of hydroquinonesulfonic acid potassium salt and ethynyl hydroquinone were called as SHQ90-EHQ10-DFDPS, SHQ80-EHQ20-DFDPS, and SHQ70-EHQ30-DFDPS, respectively. The yield of each compound was 90% or more.

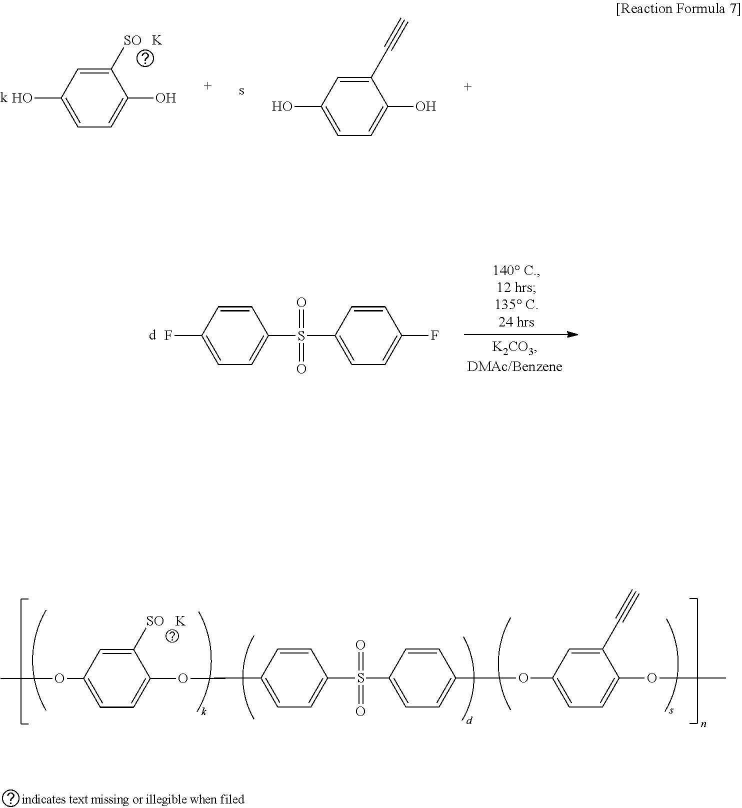

### Example 2

### Preparation of Sulfonated Poly(Arylene Ether) Copolymer Including Crosslinking Structure in Polymer Chain (SHQk-6FBPm-EHQs-DFBP, SHQk-6FBPm-EHQs-DFDPS, SHQk-BPm-EHQs-DFBP, SHIQk-BPm-EHQs-DFDPS)

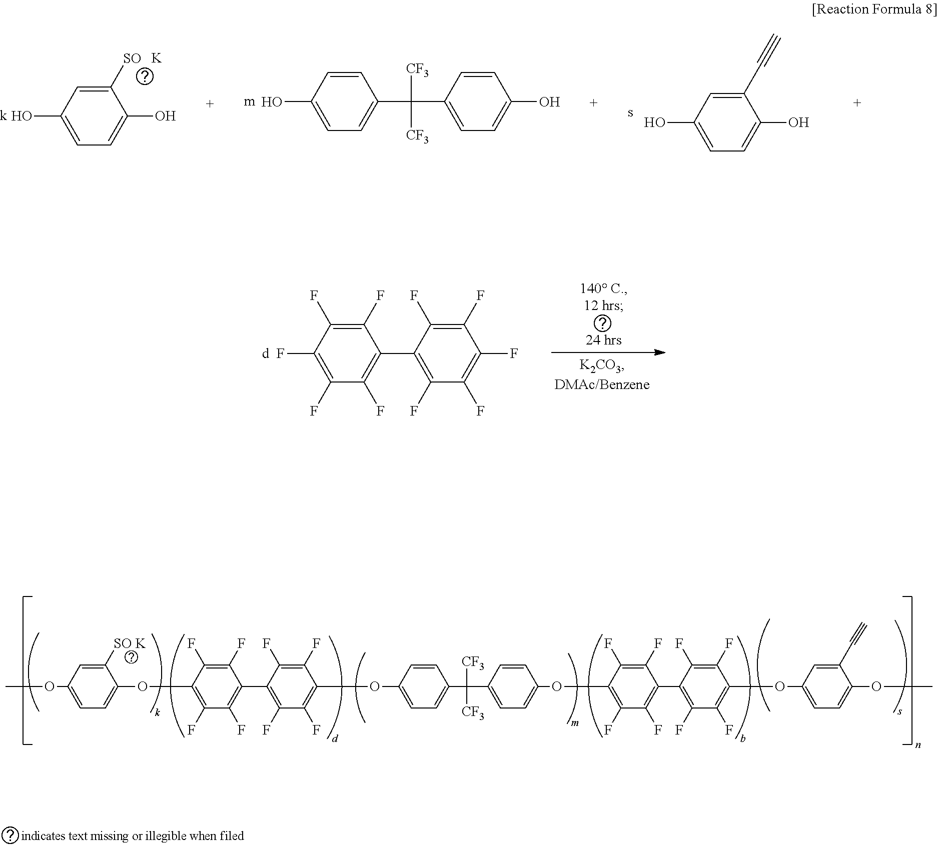

The same procedure was conducted as illustrated in Example 1, except for additionally using 2,2′-bis(4-hydroxyphenyl)hexafluoropropane) as a starting material to prepare SHQk-6FBPm-EHQs-DFBP. m represents the molar ratio of 2,2′-bis(4-hydroxyphenyl)hexafluoropropane) by the percent ratio, k represents the molar ratio of hydroquinonesulfonic acid potassium salt by the percent ratio, and s represents the molar ratio of ethynyl hydroquinone by the percent ratio.

Sulfonated poly(arylene ether) copolymers including the crosslinking structure in the polymer chain were prepared by using the starting materials of hydroquinonesulfonic acid potassium salt, ethynyl hydroquinone and 2,2′-bis(4-hydroxyphenyl)hexafluoropropane) in a molar ratio (k:m:s) of 12 mmol:1.5 mmol:1.5 mmol (k:m:s=0.8:0.1:0.1). The copolymer prepared with different molar ratio of the starting materials was called as SHQ80-6FBP10-EHQ10-DFBP. The yield of each compound was 90% or more.

The same procedure was conducted as described above, except for using 4,4′-difluorodiphenyl sulfone instead of decafluorobiphenyl as a starting material to prepare the sulfonated poly(arylene ether) copolymer including the crosslinking structure in the polymer chain, SHQk-6FBPm-EHQs-DFDPs as in Reaction Formula 10. The copolymer obtained with the molar ratio of each starting material (k:m:s) as 0.8:0.1:0.1, was called as SHQ80-6FBP10-EHQ10-DFDPs. The yield was 90% or more.

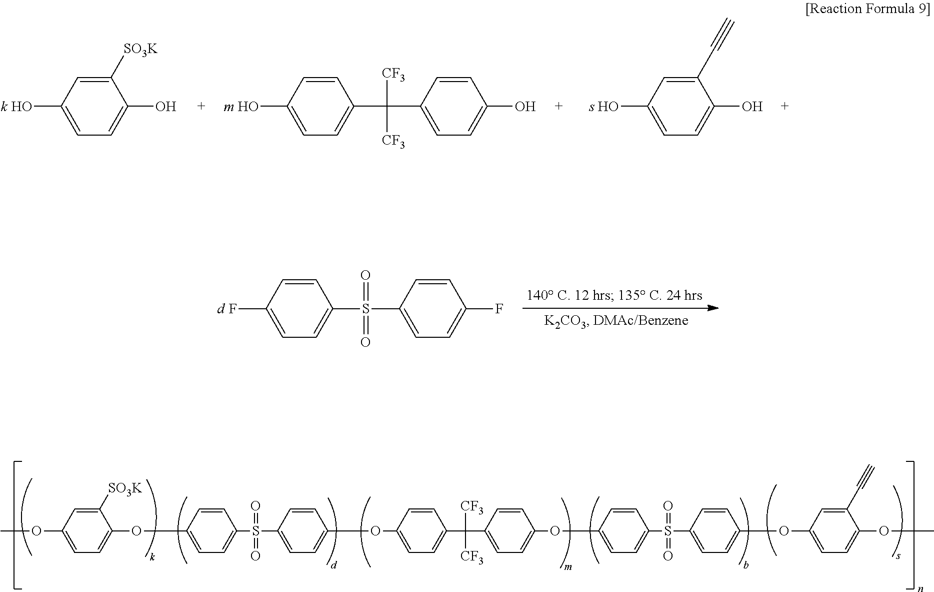

The same procedure was conducted as the above described reaction, except for using 4,4′-biphenol instead of 2,2′-bis(4-hydroxyphenyl)hexafluoropropane) as a starting material to prepare the sulfonated poly(arylene ether) copolymer including the crosslinking structure in the polymer chain, SHQk-BPm-EHQs-DFBP and SHQk-BPm-EHQs-DFDPs as in Reaction Formula 11 and Reaction Formula 12. The copolymers obtained with the molar ratio of each starting material (k:m:s) as 0.8:0.1:0.1, was called as SHQ80-BP10-EHQ10-DFBP and SHQS0-BP10-EHQ10-DFDPs. The yield was 90% or more.

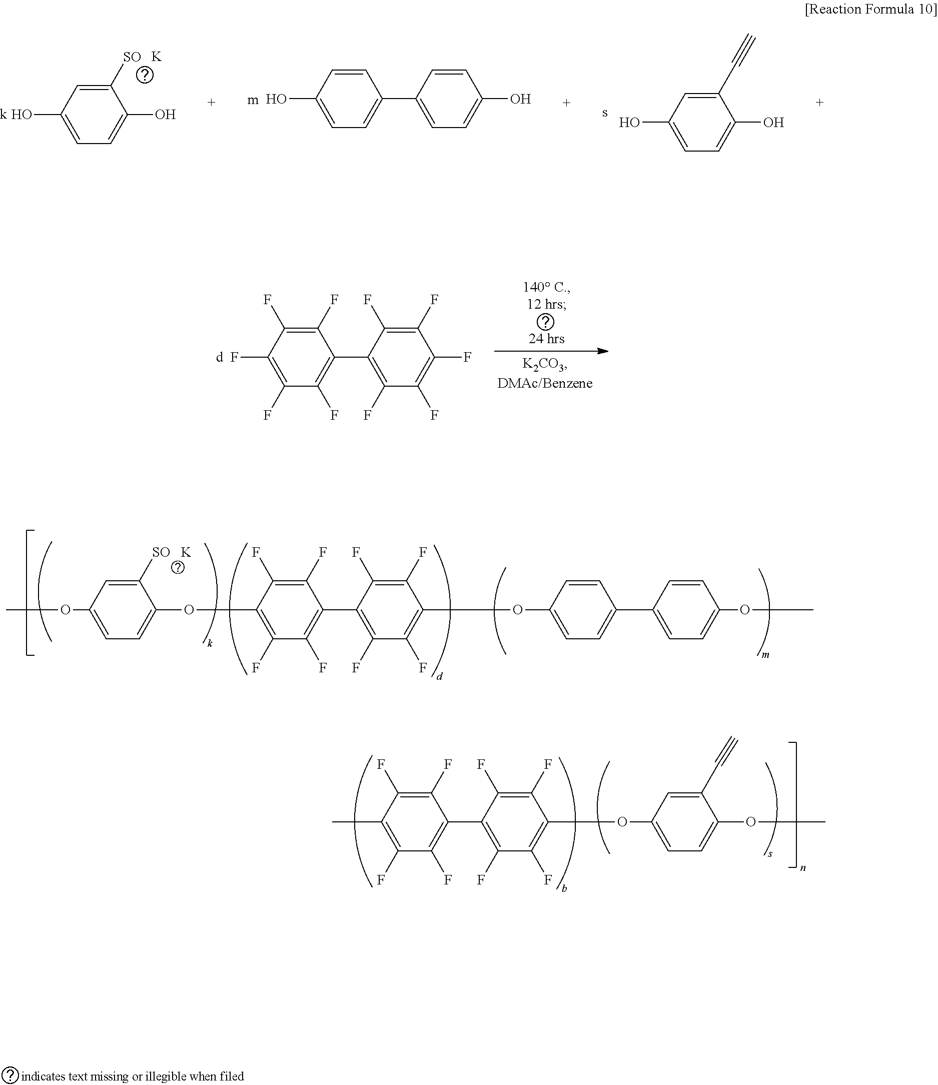

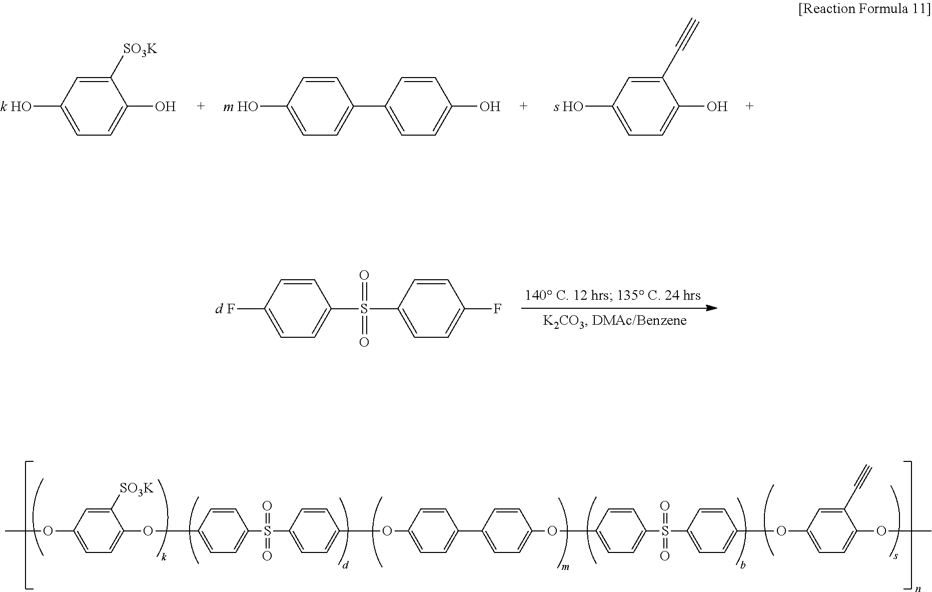

### Example 3

### Preparation of Sulfonated Poly(Arylene Ether) Copolymer Including Crosslinking Structure in Polymer Chain (SHQk-EFDHBPs-DFBP and SHQk-IEDPDHs-DFDPs)

The same procedure was conducted as described in Example 1, except for using 1-ethynyl-2,5-dihydroxybiphenyl instead of ethynyl hydroquinone to prepare SHQk-EDPHs-DFBP as in Reaction Formula 13. In addition, in the following Reaction Formula 13, SHQk-EDPHs-DFDPs as in Reaction Formula 14 may be obtained by using 4,4′-difluorodiphenyl sulfone instead of decafluorobiphenyl as a starting material. Each of the sulfonated poly(arylene ether) copolymer including the crosslinking structure in the polymer chain obtained with the molar ratio (k:s) of hydroquinonesulfonic acid potassium salt and 1-ethynyl-2,5-dihydroxybiphenyl as 0.9:0.1, was called as SHQ90-EDHBP10-DFBP and SHQ90-EDKBP10-DFDPs. The yield was 90% or more.

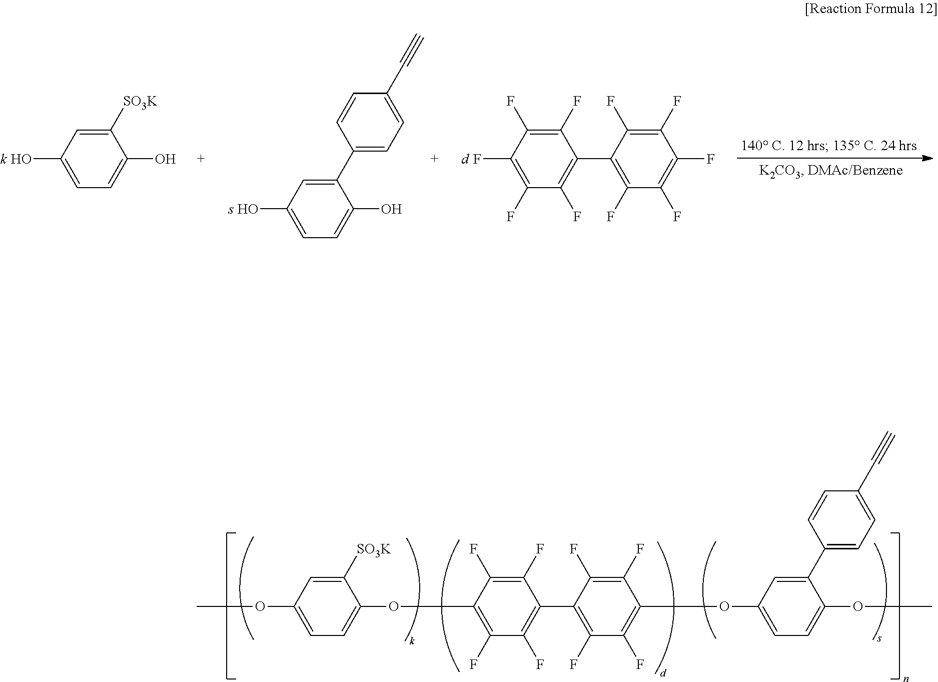

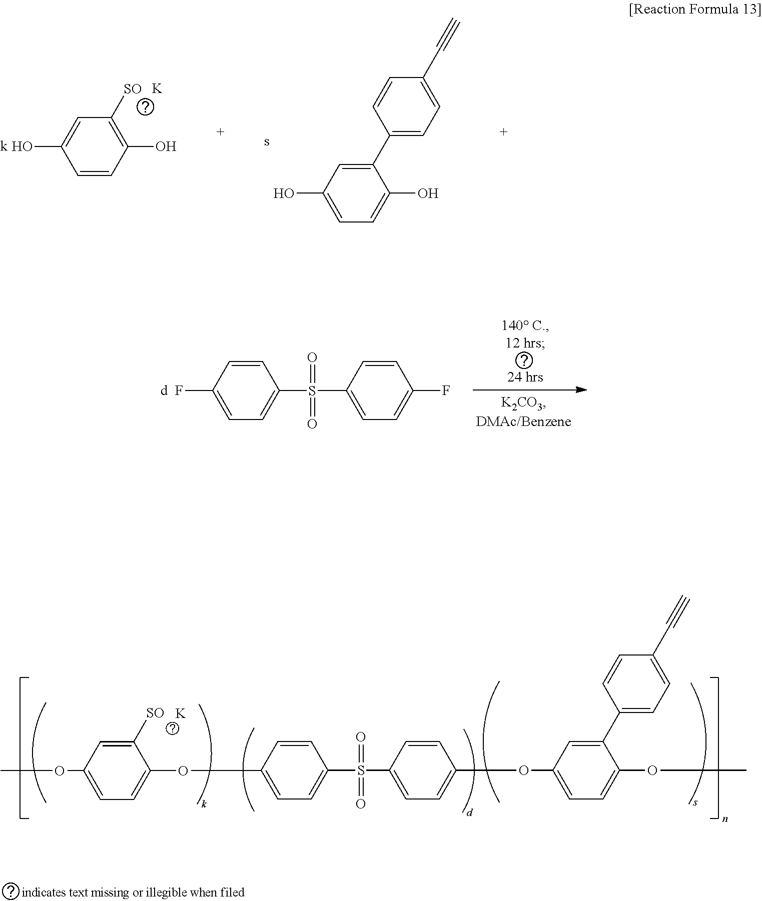

### Example 4

### Preparation of Sulfonated Poly(Arylene Ether) Copolymer Including Crosslinking Structure in Polymer Chain (SHQk-6FBPm-EDHBPs-DFBP and SHQk-6FBPmn-EDHB-Ps-DFDPS)

The same procedure was conducted as described in the above reaction, except for additionally using 2,2′-bis(4-hydroxyphenyl)hexafluoropropane) as a starting material to prepare SHQk-6FBPm-EDHBPs-DFBP through the reaction in Reaction Formula 14. m represents the molar ratio of 2,2′-bis(4-hydroxyphenyl)hexafluoropropane) by the percent ratio, k represents the molar ratio of hydroquinonesulfonic acid potassium salt by the percent ratio, and s represents the molar ratio of 1-ethynyl-2,5-dihydroxybiphenyl by the percent ratio.

Sulfonated poly(arylene ether) copolymers including the crosslinking structure in the polymer chain were prepared by using the starting materials of hydroquinonesulfonic acid potassium salt, 1-ethynyl-2,5-dihydroxybiphenyl and 2,2′-bis(4-hydroxyphenyl)hexafluoropropane) in a molar ratio (k:m:s) of 12 mmol:1.5 mmol:1.5 mmol (k:m:s=0.8:0.1:0.1). The copolymer prepared with the different molar ratio of the starting materials was called as SHQ80-6FBP10-EDHBP10-DFBP. The production yield was 90% or more.

In addition, SHQk-6FBPm-EDHBPs-DFDPS as in Reaction Formula was prepared by using 4,4′-difluorodiphenyl sulfone instead of decafluorobiphenyl. Sulfonated poly(arylene ether) copolymers including the crosslinking structure in the polymer chain were prepared by using the starting materials of hydroquinonesulfonic acid potassium salt, 1-ethynyl-2,5-dihydroxybiphenyl and 2,2′-bis(4-hydroxyphenyl)hexafluoropropane in a molar ratio (k:m:s) of 12 mmol:1.5 mmol:1.5 mmol (k:m:s=0.8:0.1:0.1). The copolymer prepared with the molar ratio of the starting materials was called as SHQ80-6FBP10-EDHBP10-DFDPS. The production yield was 90% or more.

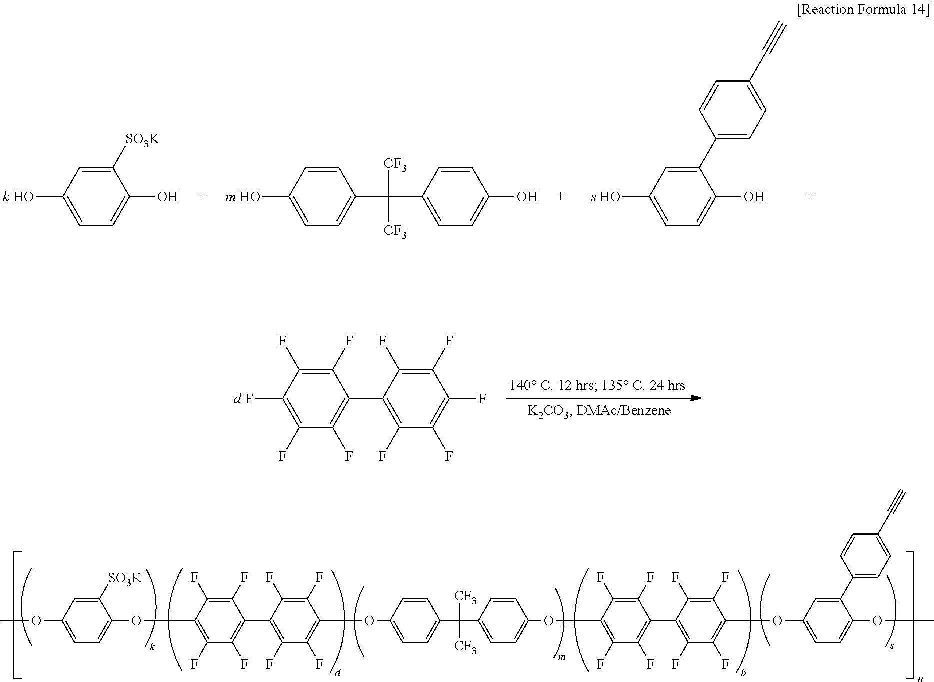

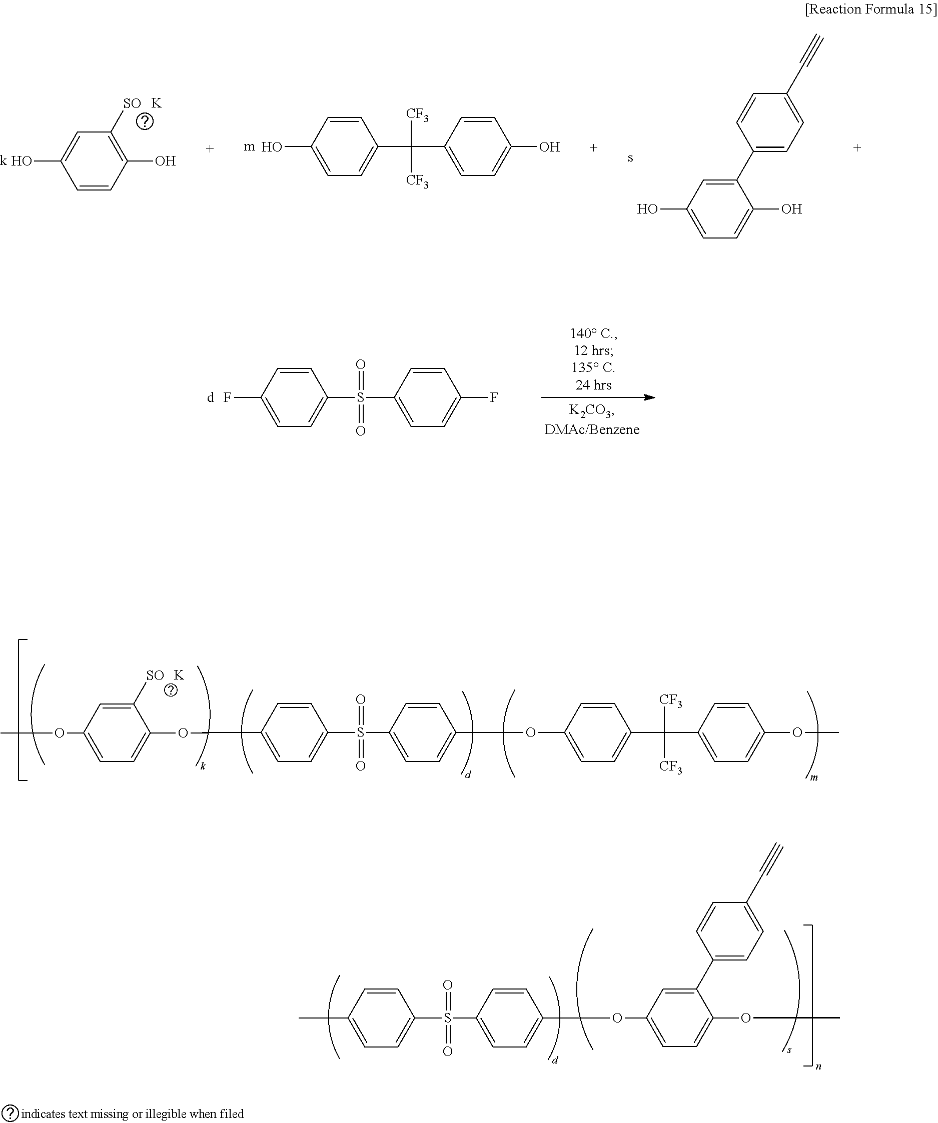

### Example 5

### Preparation of Sulfonated Poly(Arylene Ether) Copolymer Including Crosslinking Structure in Polymer Chain (SHQk-BPm-EDHBPs-DFBP and SHQk-BPm-EDHBPs-DFDPS)

The same procedure was conducted as described in the above reaction, except for using 2,2′-biphenol instead of 2,2′-bis(4-hydroxyphenyl)hexafluoropropane) to prepare SHQk-BPm-EDHBPs-DFBP through the reaction in Reaction Formula 16. m represents the molar ratio of 2,2′-biphenol by the percent ratio, k represents the molar ratio of hydroquinonesulfonic acid potassium salt by the percent ratio, and s represents the molar ratio of 1-ethynyl-2,5-dihydroxybiphenyl by the percent ratio.

Sulfonated poly(arylene ether) copolymers including the crosslinking structure in the polymer chain were prepared by using the starting materials of hydroquinonesulfonic acid potassium salt, 1-ethynyl-2,5-hydroxybiphenyl and 2,2′-biphenol in a molar ratio (k:m:s) of 12 mmol:1.5 mmol:1.5 mmol (k:m:s=0.8:0.1:0.1). The copolymer prepared with the different molar ratio of the starting materials was called as SHQ80-BP10-EDHBP10-DFBP. The production yield was 90% or more.

In addition, SHQk-BPm-EDHBPs-DFDPS as in Reaction Formula 17 was prepared by using 4,4′-difluorodiphenyl sulfone instead of decafluorobiphenyl. Sulfonated poly(arylene ether) copolymers including the crosslinking structure in the polymer chain were prepared by using the starting materials of hydroquinonesulfonic acid potassium salt, 1-ethynyl-2,5-dihydroxybiphenyl and 2,2′-biphenol in a molar ratio (k:m:s) of 12 mmol:1.5 mmol:1.5 mmol (k:m:s=0.8:0.1:0.1). The copolymer prepared with the molar ratio of the starting materials was called as SHQ80-BP10-EDHBP10-DFDPS. The production yield was 90% or more.

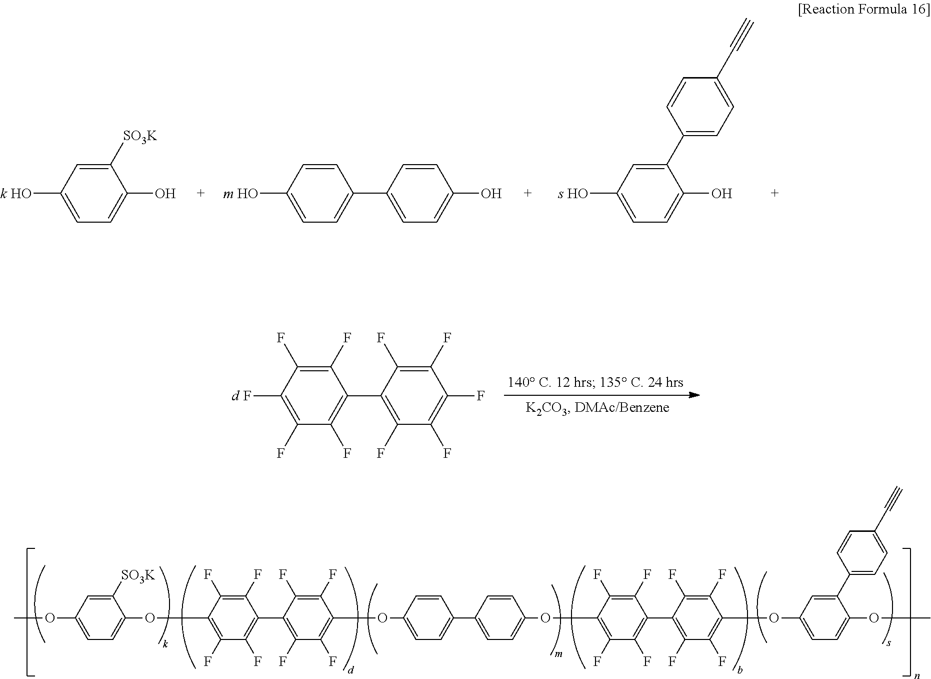

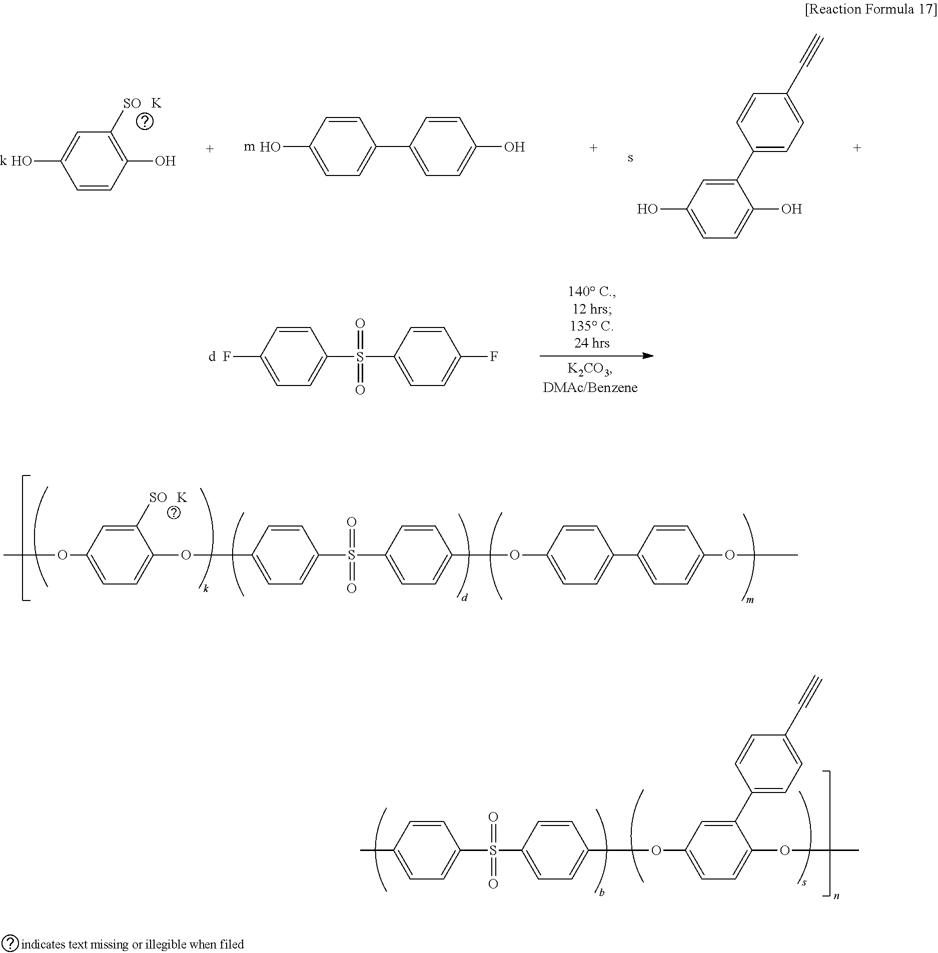

### Example 6

### Preparation of Sulfonated Poly(Arylene Ether) Copolymer Including Crosslinking Structure in Polymer Chain (6FBPk-EHQs-SDFDPS, BPk-EHQs-SDFDPS, 6FBPR-EDHBPs-SDFDPS and BPk-EDHBPs-SDFDPS)

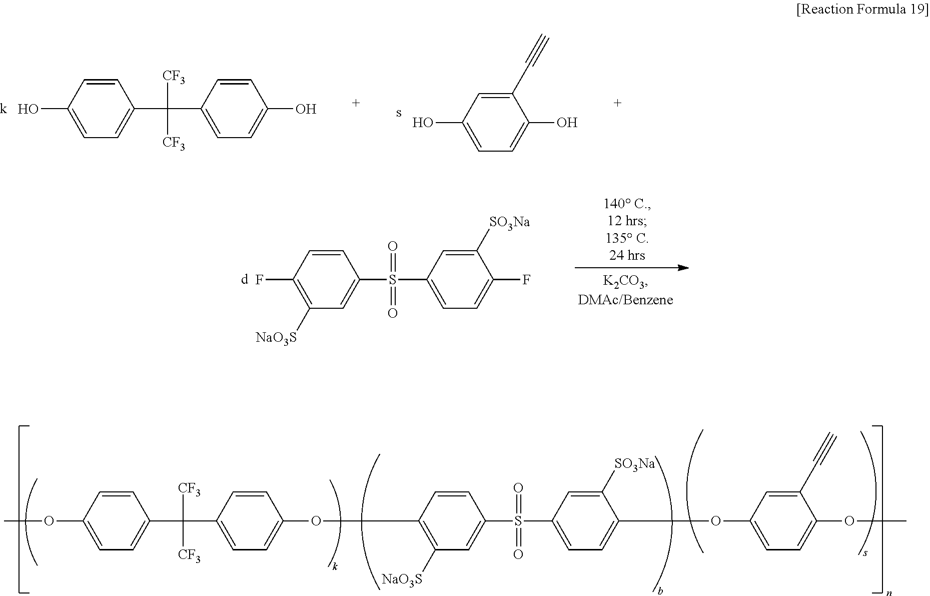

The same procedure was conducted as described in Example 1, except for using 2,2′-bis(4-hydroxyphenyl)hexafluoropropane, ethynyl hydroquinone, 3,3′-sulfonated-4,4′-di-fluorodiphenyl sulfone as starting materials to prepare 6FBPk-EHQs-SDFDPSb through the reaction as in Reaction Formula 19. Sulfonated poly(arylene ether) copolymers including the crosslinking structure in the polymer chain were prepared by using the starting materials of 2,2′-bis(4-hydroxyphenyl)hexafluoropropane and ethynyl hydroquinone in a molar ratio (k:s) of 0.9:0.1. The copolymer prepared with the molar ratio of the starting materials was called as 6FBP90-EHQ10-SDFDPs. The production yield was 90% or more.

In addition, BPk-EHQs-SDFDPS as in Reaction Formula 20 was prepared by conducting the same procedure as described above, except for using 2,2′-biphenyl instead of 2,2′-bis(4-hydroxyphenyl)hexafluoropropane. Sulfonated poly(arylene ether) copolymers including the crosslinking structure in the polymer chain were prepared by using 2,2′-biphenol and ethynyl hydroquinone in a molar ratio (k:s) of 0.9:0.1. The copolymer prepared with the molar ratio of the starting materials was called as BP90-EHQ10-SDFDPS. The production yield was 90% or more.

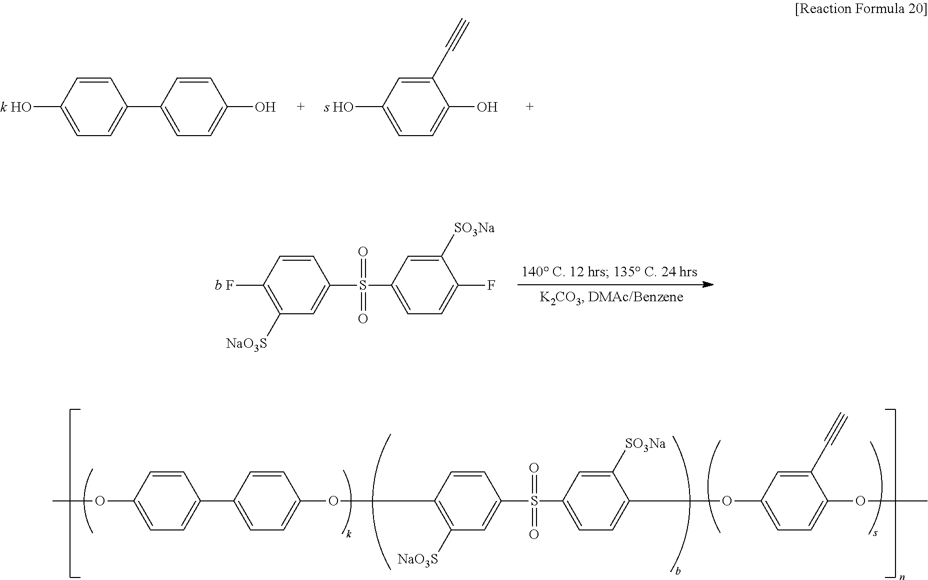

Continuously, 6FBPk-EDHBPs-SDFDPS and BPk-EDHBPs-SDFDPS as in the following Reaction Formula 21 and Reaction Formula 22 were prepared by conducting the same procedure as described above, except for using 1-ethynyl-2,5-dihydroxybiphenyl instead of ethynyl hydroquinone. Sulfonated poly(arylene ether) copolymers including the crosslinking structure in the polymer chain were prepared by using 2,2′-bis(4-hydroxyphenyl)hexafluoropropane, and 2,2′-biphenol and 1-ethynyl-2,5-dihydroxybiphenyl in a molar ratio (k:s) of 0.9:0.1. The copolymers prepared with the molar ratio of the starting materials were called as 6FBP90-EDHBP10-SDFDPS and BP90-EDHBP10-SDFDPS, respectively. The production yield was 90% or more.

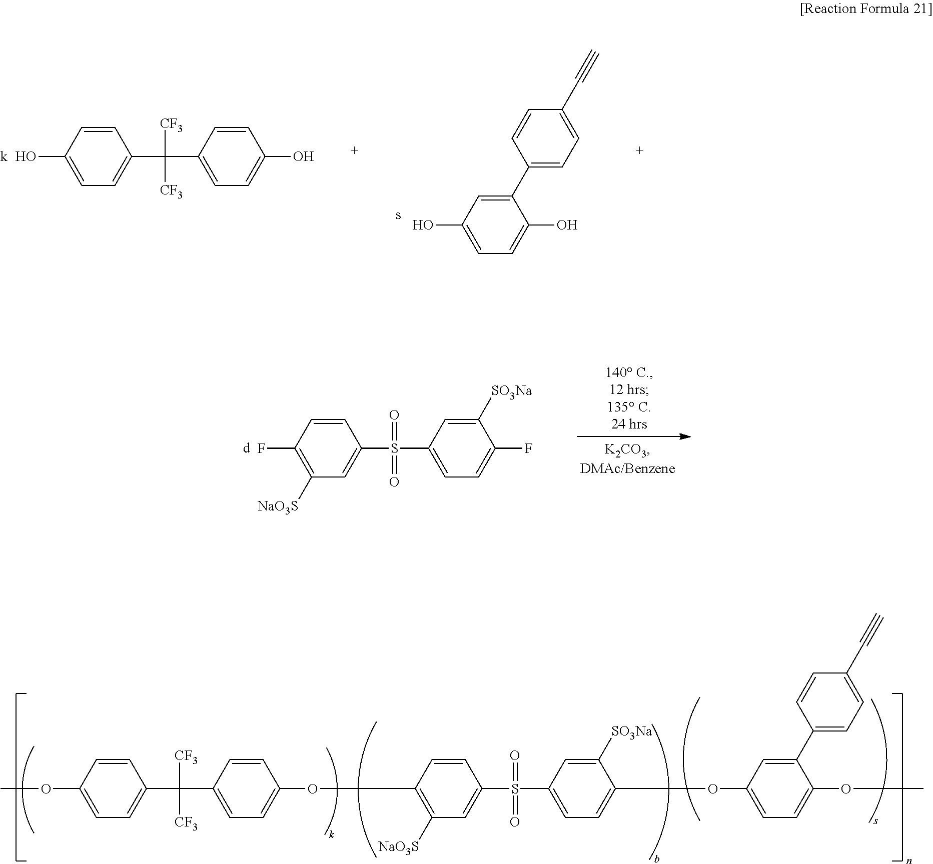

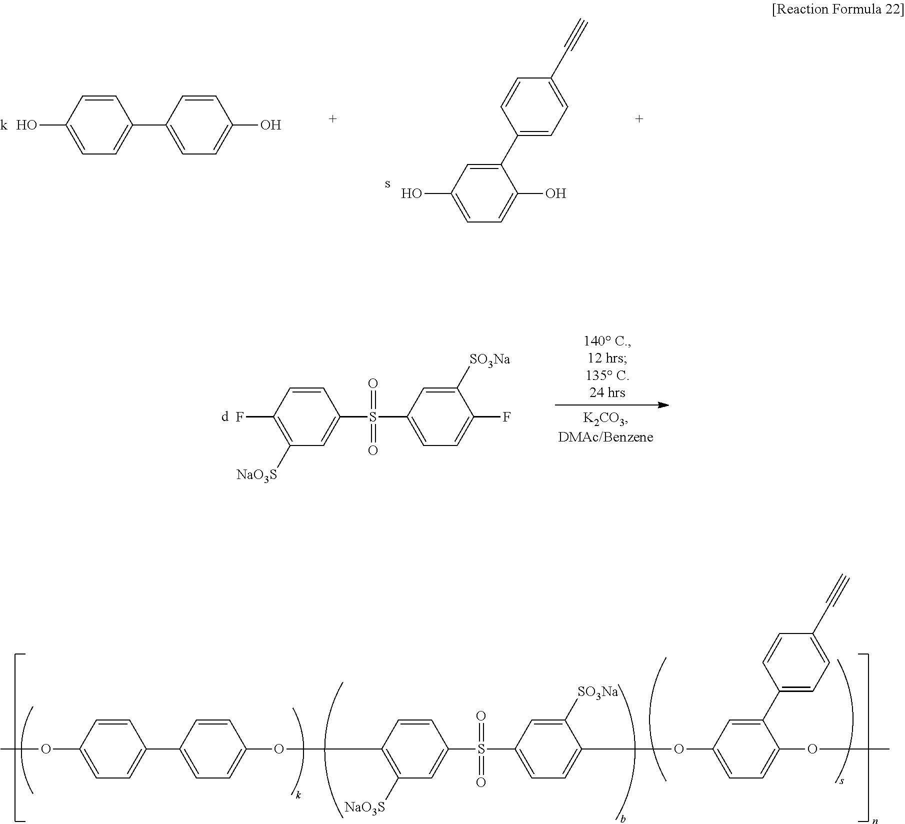

<Experiment> Manufacturing of Polyelectrolyte Membrane

The sulfonated poly(arylene ether) copolymers including the crosslinking structure prepared by Examples 1 to 6 were dissolved in a solvent and then filtered by using a PTFE membrane filter of 0.45 to 1 μm. Then, the polymer solvent was poured onto a clean glass plate supporter and stood in an oven at 50° C. for 24 hours by a casting method.

In order for performing the crosslinking in the polymer chain, a heat treatment was carried out at a temperature of 80° C. to 350° C. for 30 minutes or more. Preferably, the heat treatment was performed at 250° C. to 260° C. for 2 hours or more.

In this case, the solvent available may include a dipolar solvent such as N,N′-dimethylformamide (DMF), dimethyl acetamide (DMAc), dimethylsulfoxide (DMSO) or N-methylpyrrolidone (NMP).

After completing the heat treatment, the product was cooled to room temperature and acid treated to substitute the salt ion (Na⁺, K⁺, alkyl ammonium ion) of the sulfone moiety of the polymer prepared in Reaction Formula 5 to Reaction Formula 8 with hydrogen.

The acid treatment may be conducted by dipping the polyelectrolyte membrane in an aqueous solution of 2N sulfuric acid (H₂SO₄), an aqueous solution of 1N nitric acid (HNO₃) or an aqueous solution of 1N hydrochloric acid (HCl) for 24 hours, and then dipping in distilled water for 24 hours, or by adding the polyelectrolyte membrane in an aqueous solution of 0.5M sulfuric acid (H₂ SO₄) and then boiling for 2 hours. The method of the acid treatment is not limited to these methods.

The acid treated polyelectrolyte membrane was dipped into distilled water for 24 hours and proton conductivity was measured.

According to the names of the sulfonated poly(arylene ether) copolymers including the crosslinking structure in the polymer chain in accordance with Examples 1 to 6, the names of the thus manufactured polymer membranes may be given separately. When a polymer membrane was manufactured by using EHQk-SHQs-DFBP of Example 1, the polymer membrane may be called as c-EHQk-SHQs-DFBP. The polymer membranes manufactured by using a crosslinkable monomer including dihydroxyl group, with ethynyl hydroquinone and 1-ethynyl-2,5-dihydroxybiphenyl as starting materials among the sulfonated poly(arylene ether) copolymers disclosed in Examples 1 to 6, may be called according to the preparation order as C-SHQk-EHQs-DFBP, C-SHQk-EHQs-DFDPS, C-SHQk-6FBPm-EHQs-DFBP, C-SHQk-6FBPm-EHQs-DFDPs, C-SHQk-BPm-EHQs-DFBP, C-SHQk-BPm-EHQs-DFDPS, C-SHQk-EDHBPs-DFBP, C-SHQk-EDHBPs-DFDPS, C-SHQk-6FBPm-EDHBPs-DFBP, C-SHQk-BPm-EDHBPs-DFBP, C-SHQk-6FBPm-EDHBPs-DFDPS, C-SHQk-BPm-EDHBPs-DFDPS, C-6FBPk-EHQs-SDFDPS, C-BPk-EHQs-SDFDPS, C-6FBPk-EDHBPs-SDFDPS, C-BPk-EDHBPs-SDFDPS.

The solubility on 20 polymer membranes were measured and illustrated in the following Table 1.

TABLE 1

| polyelectrolyte | NMP | DMAc | DMSO | DMF | THF | Acetone | CHCl₃ | MeOH | Water |
|---|---|---|---|---|---|---|---|---|---|
| C-SHQk-EHQs-DFBP | I | I | I | I | I | I | I | I | I |
| C-SHQk-EHQs-DFDPs | I | I | I | I | I | I | I | I | I |
| C-SHQk-6FBPm-EHQs-DFBP | I | I | I | I | I | I | I | I | I |
| C-SHQk-6FBPm-EHQs-DFDPs | I | I | I | I | I | I | I | I | I |
| C-SHQk-BPm-EHQs-DFBP | I | I | I | I | I | I | I | I | I |
| C-SHQk-BPm-EHQs-DFDPs | I | I | I | I | I | I | I | I | I |
| C-SHQk-EDHBPs-DFBP | I | I | I | I | I | I | I | I | I |
| C-SHQk-EDHBPs-DFDPs | I | I | I | I | I | I | I | I | I |
| C-SHQk-6FBPm-EDHBPs-DFBP | I | I | I | I | I | I | I | I | I |
| C-SHQk-BPm-EDHBPs-DFBP | I | I | I | I | I | I | I | I | I |
| C-SHQk-6FBPm-EDHBPs-DFDPs | I | I | I | I | I | I | I | I | I |
| C-SHQk-BPm-EDHBPs-DFDPs | I | I | I | I | I | I | I | I | I |
| C-6FBPk-EHQs-SDFDPs | I | I | I | I | I | I | I | I | I |
| C-BPk-EHQs-SDFDPs | I | I | I | I | I | I | I | I | I |
| C-6FBPk-EDHBPs-SDFDPs | I | I | I | I | I | I | I | I | I |
| C-BPk-EDHBPs-SDFDPs | I | I | I | I | I | I | I | I | I |

S: Soluble
I: Insoluble

In Table 1, I represents insolubility in each solvent. As illustrated in Table 1, the polymer electrolyte membrane was found to be insoluble in any solvent and the crosslinking of the polymer electrolyte membrane was confirmed to be made. Further, the membranes may be known to have a good chemical stability and an excellent measuring stability.

The ion exchange capacity of the polymer electrolyte membrane manufactured in Example 5 was measured and illustrated along with that of the commonly used Nafion in Table 2.

TABLE 2

| | Ion exchange | | Ion exchange |
|---|---|---|---|
| Electrolyte membrane | capacity (meq/g) | Electrolyte membrane | capacity (meq/g) |
| C-SHQ90-EHQ10-DFBP | 1.61 | C-SHQ90-EDHBP10-DFDPS | 1.62 |
| C-SHQ80-SHQ20-DFBP | 1.46 | C-SHQ80-6FBP10-EDHBP10- | 1.59 |
| | | DFBP | |
| C-SHQ70-SHQ30-DFBP | 1.33 | C-SHQ80-BP10-EDHBP10- | 1.57 |
| | | DFBP | |
| C-SHQ90-EHQ10-DFDPS | 1.57 | C-SHQ80-6FBP10-EDHBP10- | 1.58 |
| | | DFDPS | |
| C-SHQ80-EHQ20-DFDPS | 1.41 | C-SHQ80-BP10-EDHBP10- | 1.52 |
| | | DFDPS | |
| C-SHQ70-EHQ30-DFDPS | 1.26 | C-6FBP90-EHQ10-SDFDPS | 1.63 |
| C-SHQ80-6FBP10-EHQ10- | 1.49 | C-BP90-EHQ10-SDFDPS | 1.60 |
| DFBP | | | |
| C-SHQ80-6FBP10-EHQ10- | 1.48 | C-6FBP90-EDHBP10-SDFDPS | 1.58 |
| DFDPS | | | |
| C-SHQ80-BP10-EHQ10- | 1.51 | C-BP90-EDHBP10-SDFDPS | 1.57 |
| DFBP | | | |
| C-SHQ80-BP10-EHQ10- | 1.50 | Nafion 212 | 0.91 |
| DFDPS | | | |
| C-SHQ90-EDHBP10-DFBP | 1.59 | — | — |

In Table 2, the ion exchange capacity was measured after dipping the membrane in 0.01N NaCl solution for 24 hours and titrating by using 0.01N NaOH (a phenolphthalein indicator was used).

As illustrated in Table 2, the ion exchange capacity of the thus manufactured polymer electrolyte membrane was quite high when comparing with that of Nafion. Thus, the proton conductivity of the polymer electrolyte membrane, which is one of the most significant properties, is expected to be higher than that of the Nafion.

The water uptake and the proton conductivity of the thus manufactured polymer electrolyte membrane manufactured in Example 5 are illustrated along with those of the commonly used Nafion in the following Table 3.

TABLE 3

| | Ion | Water | | Ion | Water |
|---|---|---|---|---|---|
| | conductivity | uptake | | conductivity | uptake |
| Electrolyte membrane | (S/cm) | (wt %) | Electrolyte membrane | (S/cm) | (wt %) |
| C-SHQ90-EHQ10-DFBP | 0.0884 | 78.41 | C-SHQ90-EDHBP10- | 0.0835 | 60.15 |
| | | | DFDPS | | |
| C-SHQ80-SHQ20-DFBP | 0.0789 | 48.90 | C-SHQ80-6FBP10- | 0.0817 | 60.07 |
| | | | EDHBP10-DFBP | | |
| C-SHQ70-SHQ30-DFBP | 0.0676 | 17.37 | C-SHQ80-BP10- | 0.0804 | 58.74 |
| | | | EDHBP10-DFBP | | |
| C-SHQ90-EHQ10- | 0.0863 | 72.92 | C-SHQ80-6FBP10- | 0.0811 | 60.20 |
| DFDPS | | | EDHBP10-DFDPS | | |
| C-SHQ80-EHQ20- | 0.0796 | 46.54 | C-SHQ80-BP10- | 0.0799 | 55.69 |
| DFDPS | | | EDHBP10-DFDPS | | |
| C-SHQ70-EHQ30- | 0.0717 | 19.83 | C-6FBP90-EHQ10- | 0.0869 | 67.65 |
| DFDPS | | | SDFDPS | | |
| C-SHQ80-6FBP10- | 0.0789 | 45.10 | C-BP90-EHQ10- | 0.0830 | 65.80 |
| EHQ10-DFBP | | | SDFDPS | | |
| C-SHQ80-6FBP10- | 0.0791 | 46.12 | C-6FBP90-EDHBP10- | 0.0807 | 59.66 |
| EHQ10-DFDPS | | | SDFDPS | | |
| C-SHQ80-BP10-EHQ10- | 0.0786 | 47.91 | C-BP90-EDHBP10- | 0.0800 | 59.08 |
| DFBP | | | SDFDPS | | |
| C-SHQ80-BP10-EHQ10- | 0.0784 | 48.01 | Nafion 212 | 0.0803 | 27.32 |
| DFDPS | | | | | |
| C-SHQ90-EDHBP10- | 0.0863 | 61.77 | — | | |
| DFBP | | | | | |

In Table 3, the ion conductivity was measured by means of an impedance analyzer (AutoLab, PGSTAT 30, Netherlands). (σ=(S/cm)=L/(R×A), here, L (cm) represents a distance between two electrodes, R (Ω) represents a membrane resistance, and A (cm²) represents a surface area of a membrane).

In Table 3, the water uptake was calculated by measuring the weight of the membrane (water uptake (%)=(W_{wet}−W_{dry})×1000/W_{dry}, here, W_{wet} represents the weight of the membrane in a wet state, and W_{dry} represents the weight of the membrane in a dried state)

As illustrated in Table 3, the proton conductivity, which is the most important property of a membrane, of the polyelectrolyte may be known to be similar to or improved than that of Nafion.

As illustrated in the results above, the polyelectrolyte membrane using the sulfonated poly(arylene ether) copolymer including the crosslinking structure, may have the same or better degree of a thermal stability, a mechanical stability, a chemical stability, a membrane forming capability, etc. than the commonly used polyelectrolyte membrane. In addition, the proton conductivity and the cell performance of the polyelectrolyte membrane may be remarkably improved than those of the commonly used polymer electrolyte. Further, the properties of the electrolyte membrane may be rarely changed, and a high measuring stability may be obtainable. The polyelectrolyte membrane may be used in a fuel cell or a secondary battery.

1-17. (canceled)

18. A sulfonated poly(arylene ether) copolymer represented by following Chemical Formula 1 or Chemical Formula 2:
O—SAr1-OₖAr1_{b}O—Ar2-Oₘ(Ar3_{d}O-CM-Oₛₙ [Chemical Formula 1]
O—Ar4-CₖSAr2_{b}O-CM-OₛAr5_{d}ₙ [Chemical Formula 2]
in Chemical Formula 1 and Chemical Formula 2, SAr1 and SAr2 are the same or different and independently represent a sulfonated aromatic group, Ar1, AA2, A3, Ar4 and Ar5 are the same or different and independently represent a none sulfonated aromatic group, CM represents a crosslinkable moiety, k represents a number from 0.001 to 0.999, m represents a number from 0 to 1, s represents a number of (1−k−m), b represents a number from 0.001 to 1, and d represents a number of (1−b), and n represents a repeating unit of a polymer and an integer from 10 to 500.

19. A sulfonated poly(arylene ether) copolymer represented by following Chemical Formula 3:
CM′SAr3ₖAr6ₛ-O—Ar7-Oₙ-CM′ [Chemical Formula 3]
in Chemical Formula 3, each of SAr3 independently represents a sulfonated aromatic group, each of Ar6 and Ar7 independently represents a none sulfonated aromatic group, CM′ represents a crosslinkable moiety, k represents a number from 0.001 to 0.999, and s represents a number of (1−k), and n represents a repeating unit of a polymer and an integer from to 500.

20. The sulfonated poly(arylene ether) copolymer of claim 18, wherein each of the SAr1, SAr2 or SAr3 in Chemical Formula 1, Chemical Formula 2 or Chemical Formula 3 is independently selected from the group consisting of following structures: 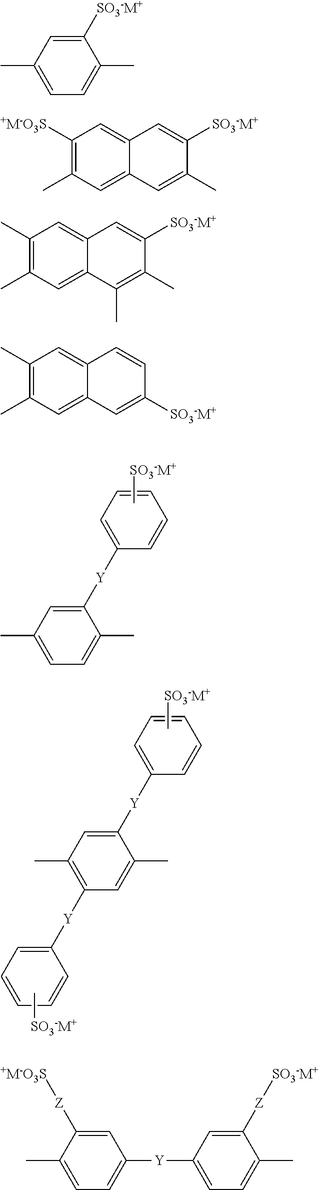
in the above structures, M⁺ represents a counterion having a cation and a potassium ion (K⁺), a sodium ion (Na⁺), or an alkyl amine (⁺NR′, here, R′ represents an alkyl group having 1 to 5 carbon atoms), and preferably represents the potassium ion or the sodium ion, Z represents a direct bonding, 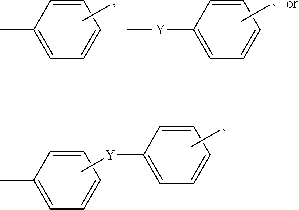
Y represents a single bonding, or is selected from the group consisting of following structures, 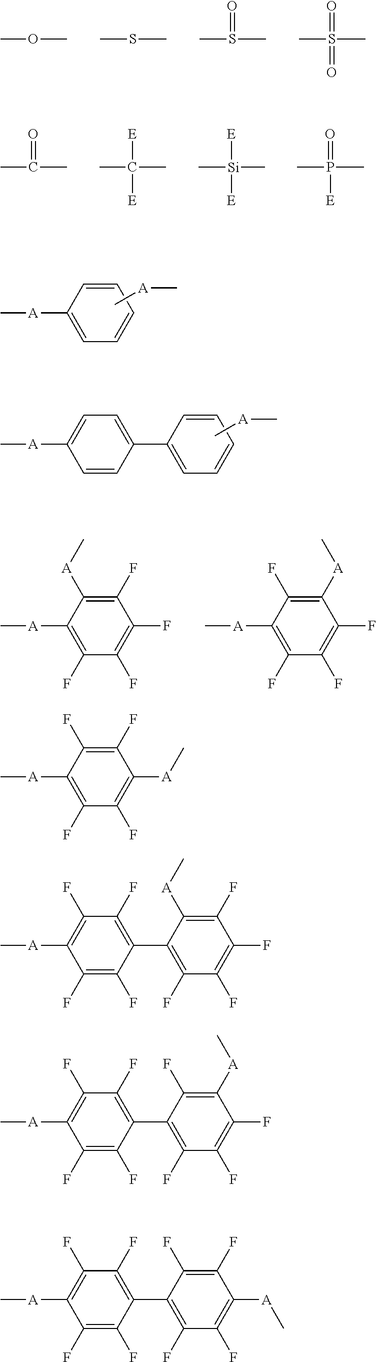
here, A represents a single bonding, 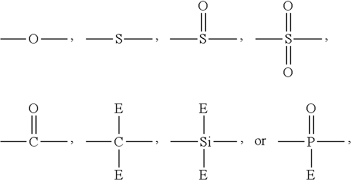
E represents H, F, an alkyl group having 1 to 5 carbon atoms, a haloalkyl group having 1 to 5 carbon atoms, or 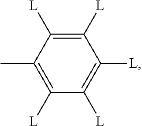
and L represents H, F, an alkyl group having 1 to 5 carbon atoms, or a haloalkyl group having 1 to 5 carbon atoms.

21. The sulfonated poly(arylene ether) copolymer of claim 19, wherein each of the SAr1, SAr2 or SAr3 in Chemical Formula 1, Chemical Formula 2 or Chemical Formula 3 is independently selected from the group consisting of following structures: 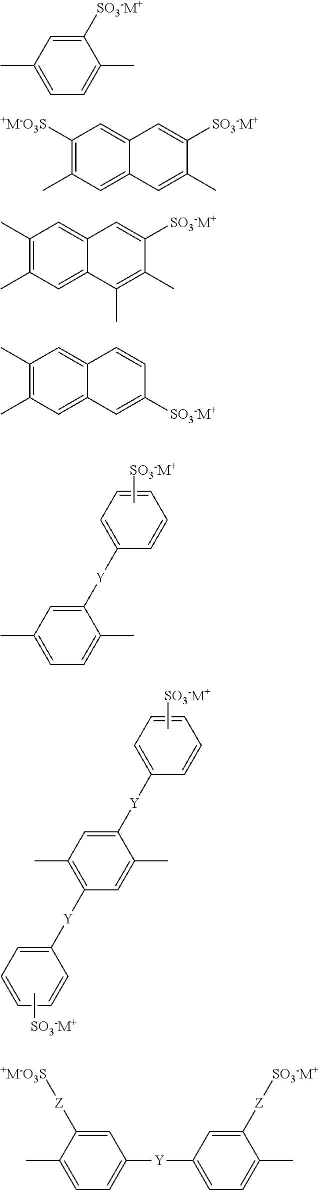
in the above structures, M⁺ represents a counterion having a cation and a potassium ion (K⁺), a sodium ion (Na⁺), or an alkyl amine (⁺NR′, here, R′ represents an alkyl group having 1 to 5 carbon atoms), and preferably represents the potassium ion or the sodium ion, Z represents a direct bonding, 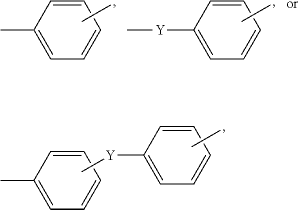
Y represents a single bonding, or is selected from the group consisting of following structures, 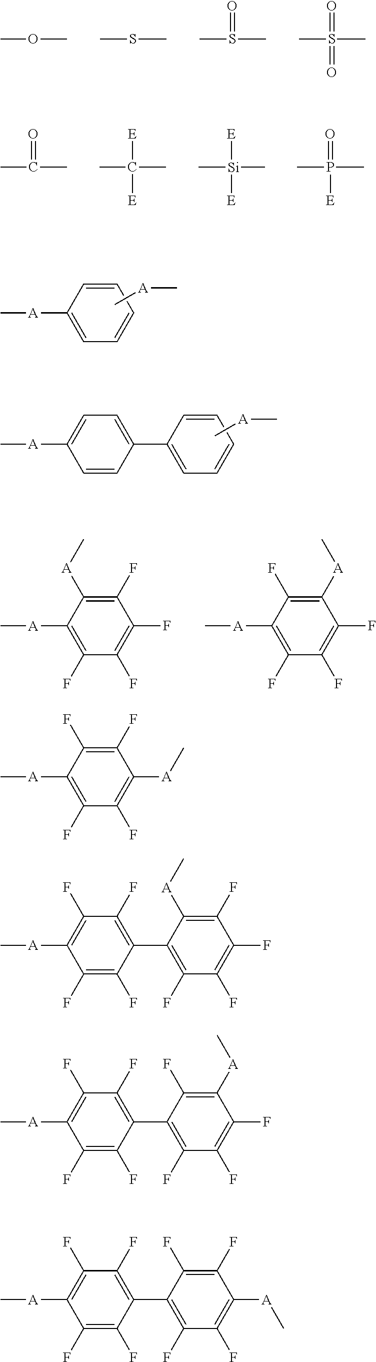
here, A represents a single bonding, 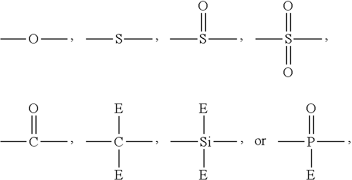
E represents H, F, an alkyl group having 1 to 5 carbon atoms, a haloalkyl group having 1 to 5 carbon atoms, or 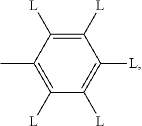
and L represents H, F, an alkyl group having 1 to 5 carbon atoms, or a haloalkyl group having 1 to 5 carbon atoms.

22. The sulfonated poly(arylene ether) copolymer of claim 18, wherein each of the Ar1, Ar2, Ar3, Ar4, Ar5, Ar6 or Ar7 in Chemical Formula 1, Chemical Formula 2 or Chemical Formula 3 is independently one selected from the group consisting of following structures: 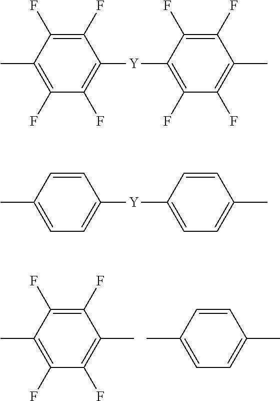
in the structures, Y represents a single bonding or one selected from the group consisting of following structures, 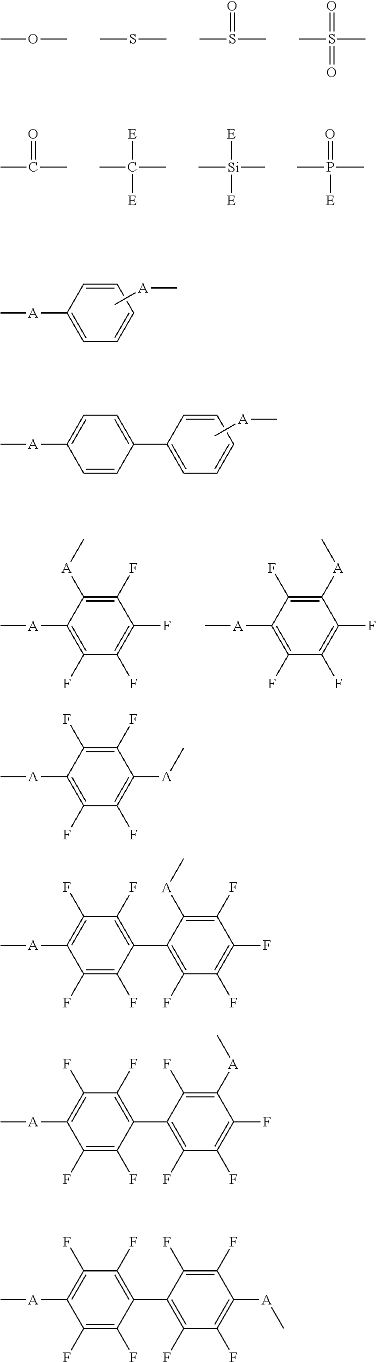
here, A represents a single bonding, or 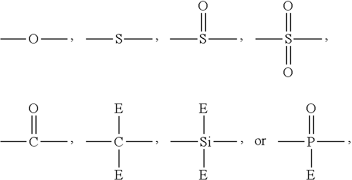
and E represents hydrogen, F, an alkyl group having 1 to 5 carbon atoms, a haloalkyl group having 1 to 5 carbon atoms, or 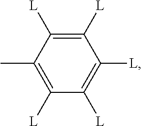
(here, L represents hydrogen, F, an alkyl group having 1 to 5 carbon atoms, or a haloalkyl group having 1 to 5 carbon atoms).

23. The sulfonated poly(arylene ether) copolymer of claim 19, wherein each of the Ar1, Ar2, Ar3, Ar4, Ar5, Ar6 or Ar7 in Chemical Formula 1, Chemical Formula 2 or Chemical Formula 3 is independently one selected from the group consisting of following structures: 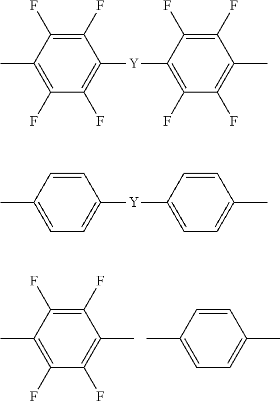
in the structures, Y represents a single bonding or one selected from the group consisting of following structures, 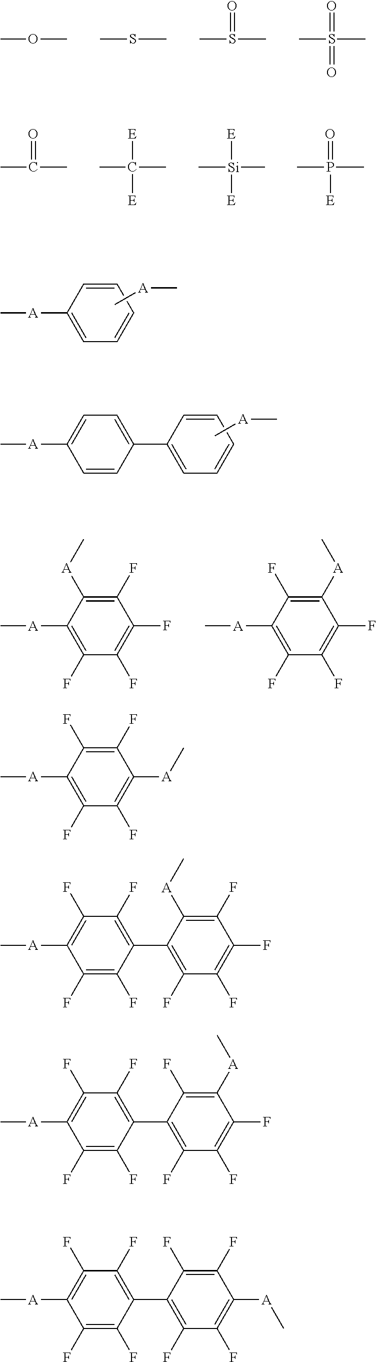
here, A represents a single bonding, or, 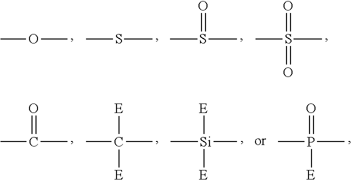
and E represents hydrogen, F, an alkyl group having 1 to 5 carbon atoms, a haloalkyl group having 1 to 5 carbon atoms, or 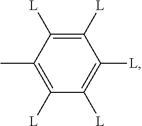
(here, L represents hydrogen, F, an alkyl group having 1 to 5 carbon atoms, or a haloalkyl group having 1 to 5 carbon atoms).

24. The sulfonated poly(arylene ether) copolymer of claim 18, wherein the CM in Chemical Formula 1 or Chemical Formula 2 is one selected from the group consisting of following structures: 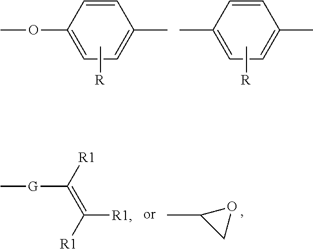
G represents a single bonding, 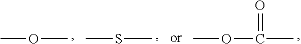
R1 represents H, F, an alkyl group having 1 to 5 carbon atoms, or 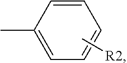
and R2 represents H, F or an alkyl group having 1 to 5 carbon atoms.

25. The sulfonated poly(arylene ether) copolymer of claim 19, wherein the CM′ of Chemical Formula 3 is one selected from the group consisting of following structures: 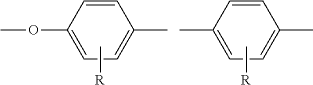
in the structures, R represents 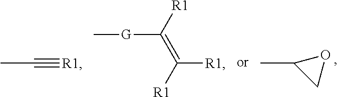
G represents a single bonding, 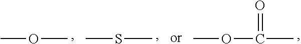
R1 represents H, F, an alkyl group having 1 to 5 carbon atoms, or 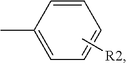
and
R2 represents H, F or an alkyl group having 1 to 5 carbon atoms.

26. A method of manufacturing a sulfonated poly(arylene ether) copolymer represented by following Chemical Formula 1 or Chemical Formula 2, the method comprising: forming a polymer by condensation polymerizing at least one monomer selected from the group consisting of a sulfonated dihydroxy monomer, a none sulfonated dihydroxy monomer, a sulfonated dihalide monomer and a none sulfonated dihalide monomer, with a crosslinkable compound;
O—SAr1-OₖAr1_{b}O—Ar2-Oₘ(Ar3_{d}O-CM-Oₛₙ [Chemical Formula 1]
O—Ar4-CₖSAr2_{b}O-CM-OₛAr5_{d}ₙ [Chemical Formula 2]
in Chemical Formula 1 and Chemical Formula 2,
SAr1 and SAr2 are the same or different and independently represent a sulfonated aromatic group,
Ar1, A2, Ar3, Ar4 and Ar5 are the same or different and independently represent a none sulfonated aromatic group,
CM represents a crosslinkable moiety,
k represents a number from 0.001 to 0.999, m represents a number from 0 to 1, s represents a number of (1−k−m), b represents a number from 0.001 to 1, and d represents a number of (1−b), and
n represents a repeating unit of a polymer and an integer from 10 to 500.

27. A method of manufacturing a sulfonated poly(arylene ether) copolymer represented by following Chemical Formula 3, the method comprising:
1) forming a polymer by condensation polymerizing at least one monomer selected from the group consisting of a sulfonated dihydroxy monomer, a none sulfonated dihydroxy monomer, a sulfonated dihalide monomer and a none sulfonated dihalide monomer; and
2) performing a substitution reaction at a terminal of the polymer using a crosslinkable compound;
CM′SAr3ₖAr6ₛ-O—Ar7-Oₙ-CM′ [Chemical Formula 3]
in Chemical Formula 3, each of SAr3 independently represents a sulfonated aromatic group, each of Ar6 and Ar7 independently represents a none sulfonated aromatic group,
CM′ represents a crosslinkable moiety,
k represents a number from 0.001 to 0.999, and
s represents a number of (1−k), and n represents a repeating unit of a polymer and an integer from 10 to 500.

28. The method of manufacturing a sulfonated poly(Arlene ether) copolymer of claim 26, wherein the crosslinkable compound includes one crosslinkable group selected from the group consisting of following structures: 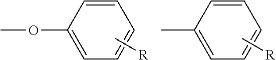
in the structures, R represents 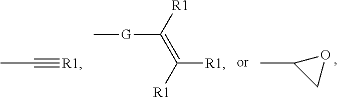
G represents a single bonding, 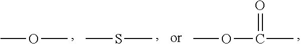
R1 represents H, F, an alkyl group having 1 to 5 carbon atoms, or 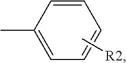
and R2 represents H, F or an alkyl group having 1 to 5 carbon atoms.

29. The method of manufacturing a sulfonated poly(Arlene ether) copolymer of claim 26, wherein the condensation polymerizing is conducted by using a base, an azeotropic solvent, and an aprotic polar solvent or a protic polar solvent at a temperature of 10° C. to 300° C.

30. The method of manufacturing a sulfonated poly(Arlene ether) copolymer of claim 27, wherein the condensation polymerizing is conducted by using a base, an azeotropic solvent, and an aprotic polar solvent or a protic polar solvent at a temperature of 10° C. to 300° C.

31. The method of manufacturing a sulfonated poly(Arlene ether) copolymer of claim 29, wherein the aprotic solvent includes at least one selected from the group consisting of N-methylpyrrolidone (NMP), dimethyl formamide (DMF), N,N-dimethyl acetamide (DMAc) and dimethyl sulfoxide (DMSO), the protic solvent includes at least one selected from the group consisting of methylene chloride (CH₂Cl₂), chloroform (CH₃Cl) and tetrahydrofuran (THF), and the azeotropic solvent includes at least one selected from the group consisting of benzene, toluene and xylene.

32. The method of manufacturing a sulfonated poly(Arlene ether) copolymer of claim 30, wherein the aprotic solvent includes at least one selected from the group consisting of N-methylpyrrolidone (NMP), dimethyl formamide (DMF), N,N-dimethyl acetamide (DMAc) and dimethyl sulfoxide (DMSO), the protic solvent includes at least one selected from the group consisting of methylene chloride (CH₂Cl₂), chloroform (CH₃Cl) and tetrahydrofuran (THF), and the azeotropic solvent includes at least one selected from the group consisting of benzene, toluene and xylene.

33. The method of manufacturing a sulfonated poly(arylene ether) copolymer of claim 27, wherein the substitution reaction in step 2) is conducted by using a phenyl compound substituted with a halide or a phenyl compound substituted with a hydroxyl group.

34. The method of manufacturing a sulfonated poly(arylene ether) copolymer of claim 33, wherein each of the phenyl compound substituted with the halide and the phenyl compound substituted with the hydroxyl group is represented by following structures: 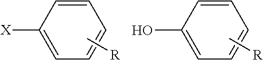
in the structures, X represents a halogen,
R represents 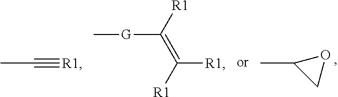
G represents a single bonding, 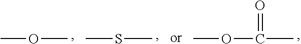
R1 represents H, F, an alkyl group having 1 to 5 carbon atoms, or 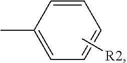
and
R2 represents H, F or an alkyl group having 1 to 5 carbon atoms.
